(19) United States
(12) Patent Application Publication
(10) Pub. No.: US 2019/0178532 A1
(43) Pub. Date: Jun. 13, 2019

(54) PROCESS FOR INCREASING THE SERVICE LIFE OF A SOLAR RECEIVER

(71) Applicant: Dow Global Technologies LLC, Midland, MI (US)

(72) Inventors: Christoph Lang, Horgen (CH); Eungkyu Kim, Midland, MI (US); Bruce S. Holden, Midland, MI (US); Bruce D. Hook, Lake Jackson, TX (US); Chet Davidson, Lake Jackson, TX (US)

(73) Assignee: Dow Global Technologies LLC, Midland, MI (US)

(21) Appl. No.: 16/323,449

(22) PCT Filed: Aug. 3, 2017
(86) PCT No.: PCT/US2017/045230

§ 371 Date: Feb. 5, 2019

Related U.S. Application Data
(60) Provisional application No. 62/371,271, filed on Aug. 5, 2016.

(51) Int. Cl. F24S 40/46; F24S 10/40; F24S 80/20

(52) U.S. Cl. CPC F24S 40/46; F24S 80/20; F24S 10/45

(57) ABSTRACT

A process for increasing the service life of a solar receiver by reducing the concentration of dissolved hydrogen present in a hydrogen atom containing liquid (HACL) stream including (a) contacting a HACL stream containing a first concentration of dissolved hydrogen with an inert gas stream under predetermined process conditions such that at least a portion of hydrogen in the HACL stream is transferred to the inert gas stream and a second reduced concentration of dissolved hydrogen remains in the HACL stream; and (b) passing the HACL stream having the second reduced concentration of dissolved hydrogen through the solar receiver.

### FIELD

The disclosure herein pertains to solar receivers used in solar thermal energy collectors. More specifically, the present invention is related to a process for increasing the service life of a solar receiver by reducing the concentration of dissolved hydrogen in a hydrogen atom containing liquid (HACL), such as a heat transfer fluid, used in one or more solar receivers of a concentrated solar power plant.

### BACKGROUND

In the solar thermal energy industry, several types of concentrated solar power (CSP) plants are known that use different types of solar receivers. Solar receivers comprising of steel pipes with vacuum between an outer glass and the inner steel wall of the pipes are predominantly used in linear solar collector systems. A heat transfer fluid (HTF) such as a HACL is typically passed through the inner space of the steel pipe of the solar receiver. The solar receivers collect heat from the sun via the concentrated collectors and transfer the heat to the HTF flowing inside the internal walls of the solar receiver. In turn, (1) the heated HTF is passed on to a power block which transforms the heat from the heated HTF to power such as steam or electricity; (2) the heated HTF is used to store energy in a thermal energy storage (TES) system; and/or (3) the heated HTF is used for other processes. In a linear solar collector system, such as parabolic trough CSP plant or a linear Fresnel collector CSP plant, a solar receiver is constructed of a steel tube encapsulated by a glass tube with a vacuum annular space between the outer wall of the steel tube and the inner wall of the glass tube. The solar receiver requires the vacuum annular space to operate efficiently.

HACLs which make up the HTFs used with solar receivers can contain dissolved diatomic hydrogen (H₂). H₂ is one product that can be formed by thermal degradation of the HACLs when the HACLs are operated at high temperatures (e.g., from 200° C. to 500° C.). And, unlike most degradation products, H₂ is able to permeate through steel walls such as steel walls of steel tubes used in solar receivers. Unfortunately, any H₂ that permeates into, and takes up space in, the vacuum space of a solar receiver can diminish the function of the vacuum space which functions to minimize convectional heat losses of the solar receiver; and the solar receiver can cease to operate as intended.

Not all parabolic trough and linear Fresnel plants use receivers with vacuum. However, non-vacuum based collectors are used at lower temperatures (e.g., less than about 200° C.) applications; and, the H₂ permeation rate is insignificant at such lower temperatures and therefore, H₂ permeation is not an issue at temperatures below 200° C.

In FIG. 1 there is shown a solar receiver 10 of parabolic trough (PT) concentrated solar power (CSP) plants including a steel tube 11 encapsulated by a glass tube 12. A heat transfer fluid (HTF) feed stream 13a is passed from entrance of the internal wall of the steel tube 11 through the steel tube 11 and the HTF exit fluid stream 13b leaves the steel tube 11 while the HTF captures heat from the sunrays (concentrated sunlight) 14 that is reflected onto the steel tube through the glass tube 12. A vacuum annular space 15 between the wall of the glass tube 12 and the wall of the steel tube 11 minimizes convectional heat losses. Keeping the vacuum in the annular space 15 of the solar receiver 10 is essential for a plant to operate efficiently. The vacuum space 15 of solar receiver 10 is equipped with a getter material 16 which is designed to capture certain quantities of H₂ that is generated from HTF degradation and that permeates through the wall of the steel tube 11 to the vacuum space 15.

With reference to FIG. 1A, there is shown a schematic illustration of the permeation action of the H₂ permeating through the thickness of the metal wall 11. The H₂ molecules themselves do not “permeate” through the metal. Instead, as shown in FIG. 1A, the “permeation” of H₂ through wall 11 undergoes a series of transformation processing steps, generally indicated by numerals I-VI, resulting in H₂ molecules being transferred from one side of the wall 11 to the other side of the wall 11. For example, the processing steps can include adsorption (step I), dissociation (step II), ionization (step III), diffusion (step IV), recombination (step V) and desorption (step VI).

With reference to FIG. 1A again, there is shown a concentration of H₂ molecules 17 present in a high pressure side 13 (the HTF side) of the metal wall 11 and a lower concentration of H₂ molecules 17 present in the other opposite side of the wall 11 which is a low pressure side 15 (vacuum side) of the metal wall 11. The processing steps I-VI resulting in H₂ molecules 17 being transferred from one side of the wall 11 to the other side of the wall may be as follows: The H₂ molecules 17 can be adsorbed (step I) onto the metal surface 11a of wall 11. At the surface 11a, the H₂ molecules 17 can be dissociated (step II) to form mono-atomic hydrogen 18. The mono-atomic hydrogen 18 can then be ionized (step III) to form an ionized mono-atomic hydrogen 19 in the metal wall 11. The ionized mono-atomic hydrogen 19 then diffuses (step IV) through the metal wall 11 diffusing from surface 11a through wall 11 to the other surface 11b of the wall 11. The ionized mono-atomic hydrogen 19 can then be recombined (steps V and VI) on or near the surface 11b and/or anywhere in the low pressure side 15 of the metal wall 11 to form H₂ 17 again. The low pressure side 15 contacting the metal surface 11b is the vacuum side of the solar device 10 of the present invention.

As the H₂ enters the vacuum space 15 permeating through the steel tube 11 of the aforementioned solar receiver 10 and as H₂ absorption, adsorption, or chemical binding is performed by the getter material 16, there is a fixed amount of time before the getter material 16 reaches its maximum limit of H₂ capacity. The time before the getter material 16 reaches its maximum limit of H₂ capacity depends mainly on temperature and H₂ concentration. The higher the temperature, the quicker H₂ permeates through the steel wall. The higher the H₂ concentration, the more H₂ permeates through the steel wall. Once the maximum limit of H₂ capacity is reached by the getter material 16, further H₂ entering the vacuum space 15 will accumulate in the vacuum space which leads to a loss of vacuum. The higher the concentration of H₂ in the HTF feed stream 13a, the more H₂ enters the vacuum space, and the quicker the getter 16 is saturated with H₂. Once the getter material is saturated with H₂, the service life of the solar receiver is diminished to a point that the getter material must be regenerated; or the whole solar receiver must be replaced. Those in the industry do not desire to replace or regenerate the getter material; or replace the whole solar receiver. The heat losses of the solar receiver can be calculated using the procedure described in the report by F. Burkholder and C. Kutscher, “Heat Loss Testing of Schott's 2008 PTR70 Parabolic Trough Receiver”, published 2014. For example, the heat losses of Schott's 2008 PTR70 Parabolic Trough Receiver at 390° C. can be measured to be about 220 W/m if the vacuum in the receiver annulus is maintained. However, if the H₂ pressure in the annulus space of the receiver increases to about 1 torr (or about 1.33 mbar) due to the getter material being saturated with H₂, the heat losses of the receiver increase by a factor of about 4, i.e., to a heat loss of about 880 W/m.

U.S. Pat. No. 8,919,124 B2 discloses a solar thermal power plant, a solar collection system, and a one-stage process for removing H₂ from a HTF of a CSP plant via a membrane. The above patent does not describe to what degree H₂ can be removed from the HTF or other means besides a membrane being useful for removing H₂ from the HTF.

### SUMMARY

If the diatomic hydrogen (H₂) concentration in a heat transfer fluid (HTF) can be minimized, the permeation rate of H₂ from a HTF to the vacuum space of a solar receiver is minimized and the saturation of H₂ in the vacuum space of a solar receiver takes longer which, in turn: (i) significantly reduces maintenance cost of a PT CSP plant, (ii) simplifies the operation of the solar receiver, and (iii) eliminates the need for getter material or at least significantly reduces the number of times the getter material must be regenerated or the number of times the whole solar receiver must be replaced. The present invention solves the problem of reducing or minimizing the H₂ concentration in the HTF which is fed into a solar receiver; thus, extending the service life of the solar receiver.

For example, in one embodiment of the present invention a process for increasing the service life of a solar receiver is provided including the steps of: (a) contacting a HACL with an inert gas stream for a time sufficient to reduce the concentration of dissolved H₂ present in a HACL; wherein the HACL contains a first initial elevated concentration of dissolved H₂, before the HACL is contacted with the inert gas stream; and wherein the contacting is performed under predetermined process conditions such that: (i) at least a portion of the first initial elevated concentration of dissolved H₂ in the HACL is transferred from the HACL to the inert gas stream during the time the HACL contacts the inert gas stream, and (ii) a second reduced concentration of dissolved H₂ remains in the HACL after the HACL contacts the inert gas stream forming a hydrogen-free HACL; and (b) passing the hydrogen-free HACL having the second reduced concentration of dissolved H₂ through a solar receiver.

The inert gas stream used in contacting the hydrogen atom containing liquid stream further includes 0 wt. % to 99.99 wt. % of vaporized HACL.

In another embodiment, the process of the present invention can include a step of removing the H₂ transferred to the inert gas stream from the inert gas stream to form a hydrogen-free inert gas stream.

In another embodiment, the process of the present invention can include a step of recycling the hydrogen-free inert gas stream from the removing step back to contacting step.

The present invention process is advantageously suitable for operating under the operating conditions of a heat transfer fluid of a concentrated solar power plant. One of the advantages of using the present invention process is that the dissolved H₂ in the heat transfer fluid used in the solar receiver can be reduced to a low concentration (e.g., to less than about 1.5 ppb) such that the service life of the solar receiver using the heat transfer fluid is increased. The service life of the solar receiver can be increased using the present invention process because the H₂ dissolved in the heat transfer fluid is largely removed from the heat transfer fluid; and when the heat transfer fluid with reduced H₂ is passed through a solar receiver, less H₂ is available to permeate through the steel walls of steel tubes used in solar receivers.

### BRIEF DESCRIPTION OF THE DRAWINGS

For the purpose of illustrating the present invention, the drawings show a form of the present invention which is presently preferred. In the drawings like elements are referenced with like numbers. Therefore, the following drawings illustrate non-limiting embodiments of the present invention wherein:

FIG. 1 is an illustration of a solar receiver of a parabolic trough concentrated solar power plant.

FIG. 2A is an expanded view of a portion of the solar receiver of FIG. 1.

FIG. 3 is a schematic flow diagram of one general embodiment of the present invention showing a two-stage H₂ removal process for removing H₂ from a liquid stream.

FIG. 3 is a schematic flow diagram of an embodiment of the present invention showing an example of a two-stage H₂ removal process from a liquid stream wherein a flash drum is used for H₂ separation from HACL and a membrane unit is part of the H₂ separation for the vapor phase. FIG. 3 is an illustration of Example 1.

FIG. 4 is a schematic flow diagram of an embodiment of the present invention showing a two-stage H₂ removal process from a liquid stream wherein a stripper is used for H₂ separation from HACL and a catalytic oxidation unit is part of the H₂ separation for the vapor phase. FIG. 4 is an illustration of Example 2.

### DETAILED DESCRIPTION

As used herein, a heat transfer fluid (“HTF”) is defined as the fluid in the inner space of piping used in a solar receiver, where the HTF under a temperature gradient with the surrounding environment either absorbs or release heat. An example of an HTF is a hydrogen atom containing liquid (“HACL”), as defined and discussed herein. For the present disclosure it is possible to exchange HTF with HACL as desired.

Hydrogen atom containing liquid (“HACL”) herein, with reference to a fluid stream, means a fluid that contains at least one hydrogen atom in the fluid's molecular structure and which is in the liquid phase at least at one pressure between about 0.5 bar absolute (bara) and about 30 bara at 400° C. Polysiloxanes and hydrocarbons are examples of HACLs.

DPO stands for diphenyl oxide. A specific example of a DPO includes a diphenyl ether with a chemical formula of C₁₂H₁₀O.

BP stands for biphenyl having a chemical formula of C₁₂H₁₀O.

MT stands for metric ton.

MW stands for megawatt.

“Hydrogen-free” herein, with reference to a fluid stream, means a fluid stream containing no H₂ or a fluid stream containing at least a minimum quantity, i.e., trace amounts or a very small concentration of H₂ in the fluid stream. For example, a hydrogen-free stream may contain generally from 0.001 ppb to about 50 ppm in one embodiment of a gas stream; from about 0.01 ppb to about 1 ppm in another embodiment; and from about 0.1 ppb to about 50 ppb. In another example, generally less than about 100 ppb in one embodiment of a liquid stream; and from about 0.1 ppb to about 30 ppb in anther embodiment; and from about 0.3 ppb to about 15 ppb in still another embodiment.

“Low boiler” herein means any component of a fluid with a boiling point below the component with the lowest boiling point that is counted as part of the main fluid composition. Low boilers of a heat transfer fluid typically are formed by thermal degradation of the components of the heat transfer fluid. The low boilers of a heat transfer fluid are typically recommended to be removed from the heat transfer fluid because the low boilers increase the system pressure and can cause cavitation in pumps and valves.

“Henry's law” is described as the portion of a gas that is dissolved in a liquid versus the portion of the gas in the gas phase above the liquid in a closed system. The amount of dissolved gas is proportional to its partial pressure in the gas phase. The proportionality factor is called the “Henry's law constant.” Henry's law can be successfully used to describe the phase behavior of a liquid containing less than 0.3 mol % of gases.

A “solar receiver” is an element that receives direct sun radiation directly or concentrated via focused collectors and transfers the heat to a material that passes the receiver and takes the heat away from the receiver. The material can be in fluid, gas or solid state. The receivers are typically designed to absorb as much heat as possible but at the same time to minimize heat losses from convection and radiation.

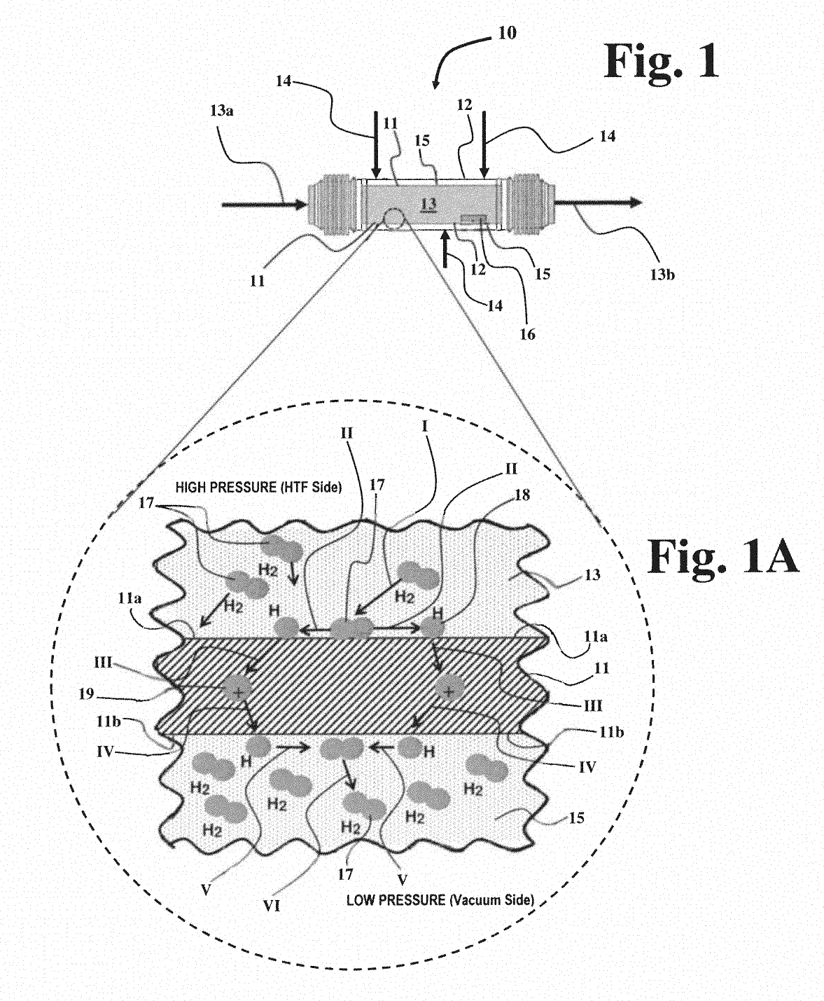

An effective way of minimizing the aforementioned heat losses can include surrounding of the receiver with a vacuum space which minimizes convectional heat losses. For example, one embodiment includes a single tube, such as a steel tube, in which the heat transfer material can be charged therethrough and a glass that surrounds the tube. The space between tube and glass can be vacuum sealed. An example of a solar receiver is shown in FIG. 1 and described herein in the present disclosure.

“Stripping” is a physical separation process where one or more components are removed from a liquid stream by contacting the liquid stream with a vapor stream. In industrial applications, the liquid and vapor streams can flow co-currently or counter-currently. Stripping is usually carried out in either a packed or trayed column.

“Thermal degradation” is a phenomenon that occurs when the breaking of one or more multiple bonds of molecules within the same molecule results in (i) more than one molecule or (ii) a reaction between two molecules forming other molecules. Thermal degradation is caused by subjecting the molecules to elevated temperatures. The molecules can form molecules with a higher or lower molecular weight than the original molecules. The velocity of the degradation reaction typically follows the Arrhenius law which means the reaction speed doubles approximately if temperature is increased by approximately 10 Kelvin.

CSP stands for concentrated solar power. Concentrated solar power (also called concentrating solar power, concentrated solar thermal, and CSP) systems generate solar power by using mirrors or lenses to concentrate a large area of sunlight, or solar thermal energy, onto a small area. Electricity can be generated when concentrated light is converted to heat, and the heat can drive a heat engine (usually a steam turbine) connected to an electrical power generator or the heat can power a thermochemical reaction.

PT stands for parabolic trough. A parabolic trough is a type of solar thermal collector that is straight in one dimension and curved as a parabola in the other two dimensions. The parabola-shaped trough may be constructed of mirror material member(s) forming a PT. The PT can be made of one mirror material member or a plurality of mirror material members which can be removably attached to a solar structure for use with in a vacuum solar receiver in the solar field. The mirror material member(s) can be made of plastic, metal, glass, or a combination thereof. For example, the parabolic shaped trough can be almost all made of a plurality of glass mirror parts connected to each other forming the PT and such PT can then be removably attached to a solar structure. The energy of sunlight, which enters the mirror parallel to the mirror's plane of symmetry, is focused along a focal line where objects that are intended to be heated are positioned. For example, food may be placed at the focal line of a trough, which causes the food to be cooked when the trough is aimed at the sun such that the sun is in the trough's plane of symmetry.

A “thermal energy storage (TES) system” is a system for wherein the energy of a HACL such as DPO/BP may be transferred to a storage medium with the purpose of charging the energy back to the HACL when not enough energy is available from a solar field to run a power block.

A “solar multiple” is a factor by which the solar field of a CSP plant is bigger than required to run the turbine of a power block at a capacity of 100% at noon. CSP plants with TES often have a solar multiple >1 in order to store energy during sunshine hours. The energy from the TES can then be used to produce electricity after sunset or when the sky is cloudy.

As used herein a “solar field” includes an area on which multiple solar collectors or/and solar receivers are installed. In case parabolic trough or linear Fresnel collectors are used in the solar field, the solar receivers are connected via pipes in parallel and in series in a way that heat transfer fluid with a feed temperature is charged via the piping system to the solar receivers of the solar field. Another piping system collects the heated heat transfer fluid from the solar receivers of the solar field and returns this heat transfer fluid from the solar field. The return temperature of the heat transfer fluid is higher than the feed temperature.

As used herein, a “power block” includes a unit in which energy of a hot material is converted into electrical energy. The power block typically includes the following equipment: one or multiple heat exchangers that bring heat to the power block via a heat transfer fluid. The heat exchangers typically transfer energy from the heat transfer fluid to a working fluid which is cycled in the power block. One or multiple turbines or other expansion machines that convert energy from the working fluid to mechanical rotation energy. One or multiple generators that convert mechanical energy into electricity. It is also possible that working fluid is heated outside the power block and therefore the heat exchangers that are described earlier are not required.

The abbreviation “ppb” stands for parts per billion; and when used in this disclosure, ppb refers to mass portions.

The abbreviation “ppm” stands for parts per million and when used in this disclosure, ppm refers to mass portions.

The abbreviation “bara” stands for bar absolute which is the unit of the absolute pressure.

The process of the present invention advantageously is useful for increasing the service life of a solar receiver. In its broadest scope, the present invention process includes a combination of at least (a) a H₂ removal process adapted to remove H₂ from a liquid stream; and (b) a solar plant process for utilizing the liquid stream to generate energy. More specifically, the present invention process can include, for example, the following steps:

(a) contacting a HACL with an inert gas stream for a time sufficient to reduce the concentration of dissolved H₂ present in a HACL; wherein the HACL contains a first initial elevated concentration of dissolved H₂, before the HACL is contacted with the inert gas stream; and wherein the contacting is performed under predetermined process conditions such that: (i) at least a portion of the first initial elevated concentration of dissolved H₂ in the HACL is transferred from the HACL to the inert gas stream during the time the HACL contacts the inert gas stream, and (ii) a second reduced concentration of dissolved H₂ remains in the HACL after the HACL contacts the inert gas stream; and

(b) passing the HACL having the second reduced concentration of dissolved H₂ through a solar receiver.

To provide an embodiment of an operable system capable of reducing the first initial elevated concentration of dissolved H₂ of the HTF to a second reduced concentration of dissolved H₂ of the HTF via the above process of the present invention, the H₂ reduction system for the HTF of PT CSP should meet the following criteria:

(1) reduce the H₂ concentration of a HTF to at least less than (<) about 15 ppb;

(2) operate at a temperature of greater than (>) about 270° C.;

(3) operate at a HTF pressure of >about 7.5 bara;

(4) require a thermal energy demand of <about 0.05% of thermal energy provided by the solar field; and

(5) require an inert gas makeup demand of <about 0.03 kg/h per MT circulated HACL.

The process of the present invention is based on a simulation process using the tool ASPEN™ PLUS version 8.6. The relevant data for the simulation includes the solubility of H₂, N₂ and water (H₂O) in diphenyl oxide/biphenyl (DPO/BP) which has been determined experimentally to be 7, 13 and 22, respectively as described by Henry's law equations.

In one specific embodiment, for example, the process disclosed herein can include a two-stage process to reduce the concentration of dissolved H₂ in a HACL to a H₂ concentration of less than 1.5 ppb. In addition, the process of the present invention can operate at over 7.5 bara pressure and 270° C. which is one embodiment of the operating conditions of the HTF of a concentrated solar power (CSP) plant. The energy demand for the present invention process in a parabolic trough (PT) CSP plant can be below 0.03% of thermal energy available from the solar field.

The process of the present invention includes the step of contacting a HACL-based stream with an inert gas stream sufficient to reduce a first initial elevated concentration of dissolved H₂ present in the HACL. During this contact step at least a portion of the first initial elevated concentration of dissolved H₂ in the HACL is transferred from the HACL to the inert gas stream. After the contacting step a second reduced concentration of dissolved H₂ remains in the HACL such that the HACL containing the reduced H₂ can be used as a heat transfer fluid in a solar receiver of a concentrated solar power (CSP) plant.

The inert gas stream used in contacting the hydrogen atom containing liquid stream further includes 0 wt. % to 99.99 wt. % of vaporized HACL.

In one general embodiment, the inert gas stream useful in the present invention may include for example one or more of the following: nitrogen (N₂), carbon dioxide (CO₂), helium (He), neon (Ne), argon (Ar), krypton (Kr), xenon (Xe), methane (CH₄), ethane (C₂H₆) and mixtures thereof. Impurities of from about 1 ppb to about 1 ppm of H₂ may be present in the gas stream. Other minor impurities such as H₂O, methane or ethane may also be present in the gas stream since such impurities may be considered not to impact the process.

In one general embodiment, the HACL useful in the present invention may include for example diphenyl oxide, biphenyl, terphenyls, naphthalene, dibenzofurane, alkylnaphthalenes, partially hydrogenated terphenyls, dibenzyltoluene, dibenzyl ethane, methylpolysiloxane, linear methylpolysiloxanes, cyclic methylpolysiloxanes and mixtures thereof. In one specific preferred embodiment, the HACL may include for example a blend of 73.5% by weight diphenyl oxide and 26.5% by weight biphenyl

The first initial elevated concentration of dissolved H₂ present in the HACL can be greater than about 0.3 ppb in one embodiment, greater than about 1 ppb in another embodiment, and greater than about 3.5 ppb in still another embodiment. Also, the first initial elevated concentration of dissolved H₂ present in the HACL can be less than about 150 ppb in one embodiment, less than about 50 ppb in another embodiment, and less than about 15 ppb in still another embodiment. Generally, first initial elevated concentration of dissolved H₂ present in the HACL can be from about 1 ppb to about 150 ppb in one embodiment, from about 1 ppb to about 15 ppb in another embodiment, and from about 1 ppb to about 3.5 ppb in still another embodiment. Higher concentrations above about 150 ppb of the first initial concentration of dissolved H₂ present in the HACL of CSP plants would be uneconomical using the present invention because any H₂ that is formed at above about 150 ppb may leave the system via the hot piping system in stream (k) as the H₂ is formed. Lower inlet concentrations below about 0.3 ppb are not expected because this is the minimum concentration increase that is expected when the HACL passes the solar field.

As used herein a “hot piping system” includes pipes that are connected with the hot outlets of the solar receivers of the solar field. These pipes are typically combined to one or a few pipes with bigger diameters than the pipes at the exit of the solar receivers. The combined pipes are lined to the power block and optionally to a TES system, where the temperature of the HTF is reduced; and/or the combined pipes are lined to other processes. As the temperature of the HTF is at its maximum in this piping system, most H₂ is produced there, but also most H₂ leaves this piping system via permeation through the steel walls of the piping system.

In a general embodiment, at least a portion of the first initial elevated concentration of dissolved H₂ in the HACL is transferred from the HACL to the inert gas stream during the contacting step resulting in a HACL containing a second reduced concentration of dissolved H₂. For example, the second concentration of dissolved H₂ present in the HACL, after the contacting step, can be less than 20 ppb in one embodiment, from about 0.1 ppb to about 12 ppb in another embodiment, from about 0.2 ppb to about 10 ppb in still another embodiment, and from about 0.2 ppb to about 1 ppb in yet another embodiment. A second reduced concentration of dissolved H₂ lower than about 0.1 ppb requires a more efficient H₂ removal unit whose dimensions may be too big to be economical for the application of the present invention process. A second reduced concentration of dissolved H₂ higher than about 20 ppb would not prolong the receiver life time sufficiently to justify the installation of a H₂ removal unit and the application of the present invention process.

Embodiments of the present disclosure are highly applicable to concentrated solar power (CSP) plants with linear receivers, where such CSP plants can be operated at solar field outlet temperatures of the HTF (e.g., HACL) higher than 390° C. (e.g., 395° C., 400° C., 410° C., 420° C. or 450° C.). Using the HTF at this higher temperature can increase the steam temperature that enters the turbine, which helps to improve efficiencies and lower the cost of electricity production. The higher operating temperature, however, can also cause the HACL to generate more H₂, where the H₂ permeation rate through receiver construction materials such as stainless steel exponentially increases with increasing temperatures. Increases in H₂ permeation rate can act to reduce the receiver life time. As such, it is important to reduce the H₂ permeation rate by the reduction of the H₂ concentration in the HTF, which can be provided by the process of the present disclosure.

To obtain a HTF (e.g., HACL) having a reduced concentration of dissolved H₂, the contacting step (a) can be carried out at a temperature of from about 0° C. to about 500° C. in one embodiment, from about 200° C. to about 450° C. in another embodiment, from about 250° C. to about 400° C. in still another embodiment, and from about 260° C. to about 320° C. in yet another embodiment. Lower temperatures than about 0° C. may not be useful in a CSP plant and lowering of the operating temperature artificially would incur high operating costs. Higher temperatures than about 500° C. may not useful in CSP plants.

The contacting step (a) can also be carried out at a pressure of from about 1 bara to about 40 bara in one embodiment, from about 5 bara to about 20 bara in another embodiment, from about 7 bara to about 15 bara in still another embodiment, and from about 10 bara to about 14 bara in yet another embodiment. The efficiency at pressures lower than about 1 bara may increase, however the power required to bring the HACL back to the operating pressure of a PT CSP plant would be uneconomically higher. Pressures higher than about 40 bara may not be useful in a CSP plant. The efficiency of H₂ separation may not be sufficient at such high pressures.

The contacting of the HACL with the inert gas stream can be done by passing the inert gas counter-current and in close contact to the HACL at an inert gas stream to HACL mass ratio of from about 1:2 to about 1:30,000 in one embodiment, from about 1:20 to about 1:2,000 in another embodiment, and from about 1:40 to about 1:200 in yet another embodiment. An inert gas stream to HACL mass ratio is dependent on H₂ formation rate from both the solar field and hot pipe, target concentration of H₂ in hydrogen-free HTF stream which is recycled back to the solar field, and type of a stripping process (e.g., stripping process with 2-stage vs. 3-stage).

The HACL described above having the second reduced concentration of dissolved H₂ can be passed through the internal space of a tube of a solar receiver of a CSP to begin the process of harnessing solar energy from the rays of the sun.

Generally, the HACL is passed through the solar receiver at a velocity of from about 0.1 m/s to about 10 m/s in one embodiment, from about 0.5 m/s to about 3 m/s in another embodiment, from about 2 m/s to about 3 m/s in still another embodiment.

As the HACL is passed through the solar receiver at the above flow rate, dissolved H₂ permeates from the HACL to the annulus vacuum space at one receiver of 4 m length with an inner tube made of 316L stainless steel, whereof the inner tube diameter is 70 mm and the wall thickness is 2 mm at 390° C. operating temperature at a rate of from about 0.1 μmol/hr to about 1,000 μmol/hr in one embodiment, from about μmol/hr to about 500 μmol/hr in another embodiment, and from about 15 μmol/hr to about 200 μmol/hr in still another embodiment.

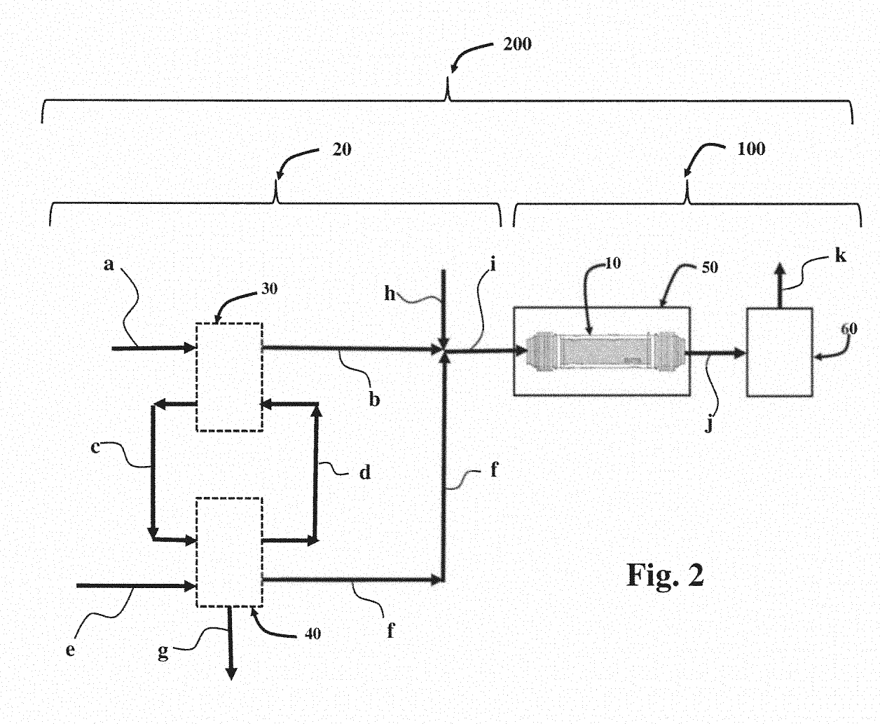

The contacting of the HACL with the inert gas stream can be done using various methods, techniques and equipment; and can be done in one or more steps or stages. In one embodiment for example, the contacting of the HACL with the inert gas stream can be done in two-stages (see FIG. 2) as described herein below.

A schematic flow diagram of one general embodiment of a two-stage process of the present invention generally indicated by numeral 200 is shown in FIG. 2. The process 200 combines: (1) the H₂ removal process generally indicated by numeral 20 used to remove H₂ from a liquid stream and (2) a solar plant process generally indicated by numeral 100 for utilizing the liquid stream to generate energy. The H₂ removal process 20 including stage 1 and stage 2 processing steps. With reference to FIG. 2, there is shown a H₂-rich HACL feed stream (a) which enters a first stage (or “stage 1”) of the process generally indicated by numeral 30 (herein “stage 30”); and a H₂-poor HACL (b) which exits stage 30 of the process. The H₂-poor HACL (b) exiting from stage 30 can be formed by introducing a vapor stream (d) that contains HACL vapors and inert gas into stage 30 and contacting the H₂-rich HACL (a) with the vapor stream (d), in a counter flow direction to the HACL (b). The contacting is carried out at a predetermined flow rate of the streams and at a predetermined residence time in stage 30 such that, upon contact, at least a portion of the H₂ in the H₂-rich HACL (a) is transferred from the HACL stream (a) to the vapor stream (c). The vapor stream (d) enters stage 30 as a H₂-poor gas stream (d) and then exits stage 30 as a H₂-rich gas stream (c). Then, the H₂-rich gas stream (c) is fed into a second stage (or “stage 2”) of the process generally indicated by numeral 40 (herein “stage 40”). The H₂-rich gas stream (c) may also pick up HACL vapors that enter stage 40.

With reference to FIG. 2 again, there is shown the H₂-poor vapor stream (d) exiting from stage 40 and being fed into stage 30. Stream (d) can be formed by applying a method of removing H₂ from the vapor stream (c). Although not shown in FIG. 2, alternatively the inert gas stream (e) may be passed through stage 40 in a counter current flow direction to the gas stream (c). In stage 40, H₂ is removed from the vapor stream (c) and forms the vapor stream (d) that exits stage 40 and enters stage 30. FIG. 2 shows the vapor stream (d) being reused in stage 30. Although not shown in FIG. 2, the vapor stream (d) can be sent, as a separate stream, to another processing unit for further processing. In stage 40, the HACL from stream (c) may also be condensed and introduced into a knock out pot (not shown) where HACLs can be partially or completely separated from the gas stream (c) and charged back to stream (b) via recycle stream (f). As used herein, a “vent knock out pot” includes a knock out pot that is used for separating less volatile components such as DPO/BP from a vent vapor stream. The gas stream (d) returning to stage 30 may contain HACL vapors that are not separated in stage 40. Although not shown in FIG. 2, alternatively the stream (f) of condensed HACLs can be sent, as a separate stream, to another processing unit for further processing. In another embodiment, an HACL makeup stream (h) may be optionally added to stream (b).

In another embodiment, stage 40 may optionally be used to remove H₂ from stream (c) by reacting the H₂ present in stream (c) with other reactive products and forming H₂ reactants which can then be separated from the inert gas stream (c). In still another embodiment, stage 40 can optionally be used to separate the H₂ as a separate stream from the vapor stream (c). The reactants of H₂ and/or the separated H₂ may be removed from stage 40 via stream (g). Stream (g) may also contain a mixture of HACLs and inert gas. If desired, the HACLs in stream (g) can be removed from the inert gas; and these removed HACLs may be fed back into stream (b), as a separate stream, such as via HACL stream (f). Analogous to the HACLs removed from stream (g), the inert gas may also be removed from the mixed stream (g) and then the removed inert gas can be re-injected into stream (e) (not shown).

The present invention process, generally indicated by numeral 200, shown in FIG. 2 combines: (1) the H₂ removal process generally indicated by numeral 20 which is utilized to remove H₂ from a liquid stream as described above, and (2) a solar plant process generally indicated by numeral 100 which is utilized to generate energy from the liquid stream flowing from the H₂ removal process 20. In one embodiment, the H₂-poor HACL stream (b) exits from stage 30 and then if needed, an HACL makeup stream (h) may be optionally added to stream (b). In another embodiment, stream (f) can be optionally mixed with the H₂-poor HACL stream (b) at a point in stream (b); and/or, in another embodiment, stream (f) can be optionally mixed with HACL stream (i) at a point in stream (i). Stream (i) is the feed stream (i) which can be fed to a solar plant generally indicated by numeral 100 through solar receiver 10 using one or several pumps (not shown). The solar plant 100 includes a solar field generally indicated by numeral 50 and one or more users of energy generated by solar field 50. The user such as a power block can be generally indicated by numeral 60 in fluid flow communication with solar field 50. The solar field 50, in one embodiment, can have a plurality of solar receivers 10 (as described in FIG. 1) that can be connected in parallel and/or sequentially in a row. In FIG. 2, there is shown a single solar receiver 10 representing one or more solar receivers that make up the solar field 50 for purposes of illustrating the present invention and not to be limited thereby.

FIG. 2 shows feed stream (i) entering the solar receiver 10, passing through the internal space of the receiver 10, and then exiting the solar receiver 10 as exit stream (j) which has been heated by solar energy. The hot stream (j) can then be sent to the users 60 via a pipe system (not shown) where the hot stream (j) is cooled and exits the users 60 as stream (k). The users 60 can be a power block where the energy from the heated fluid received from the solar receiver 10 is used to evaporate condensate into steam for electrical energy production or the heat is used for any other processes. Alternatively, users can be a TES system (not shown) or any other process that needs heat. In an optional embodiment, a portion or all of stream (k) from the user 60 can flow back to stream (a) as a recycle stream (not shown).

Stage 30 of the contacting of the HACL with the inert gas stream can also be done using various methods, techniques and equipment. In one embodiment for example, stage 30 of contacting of the HACL with the inert gas stream can be done in one or more of the following process and equipment as described herein below.

In one embodiment, a flash drum can be used in stage 30 of the present invention process. The flash drum has the function to separate liquid and gas phases of a stream that enters the flash drum. The vapor phase exits at the top of the vessel and the liquid phase at the bottom of the vessel. The flash drum can be used to separate dissolved H₂ or other gases from a feed stream. One option to carry out the separation can include the reduction of the feed stream pressure, which results in a lower solubility of vapors in the feed which, in turn, triggers the separation of the liquid phase from the vapor phase in the vessel. In another embodiment, optionally the flash drum can include the use of a mixture of a stripping gas with the liquid feed before it enters the vessel. The contact of stripping gas and the liquid in the feed stream makes volatiles and gases of the liquid to move to the stripping gas, which is separated from the liquid in the flash drum. In still another embodiment, both options described can also be combined. In yet another embodiment, the process using a flash drum can include the step of pre-heating the feed to increase the volatility which can be done in combination with either or both of the other embodiments described above.

A flash drum process to remove H₂ from a HACL, such as DPO/BP heat transfer fluid, uses a H₂-poor gas for stripping. This is a challenge for CSP plants for example because such CSP plants require nitrogen (N₂) with a purity of 99.99%. The pure N₂ can be typically supplied by trucks. The delivery and the provision of the N₂ is associated with costs that could be minimized if a used (non-purity) gas for stripping could be regenerated. The present invention combines stages to remove H₂ from the liquid and gas phase in a process that minimizes makeup and energy demand.

An operation of stripping without gas regeneration in CSP would require a higher purity of inert gas than an operation of stripping with gas regeneration because more impurities from the inert gas would come in contact with the HACL, if the inert gas is not regenerated and reused. More impurities in the HACL can result in accelerated thermal degradation of the HACL in CSP plants. The use of a second stage (stage 2 or stage 40) allows the recovery of the inert gas and minimizes makeup of inert gas and HACL that leave the first stage (stage 1 or stage 30) in the vapor phase. Therefore, a reduced demand of inert gas and HACL can reduce the cost of operating a CSP plant.

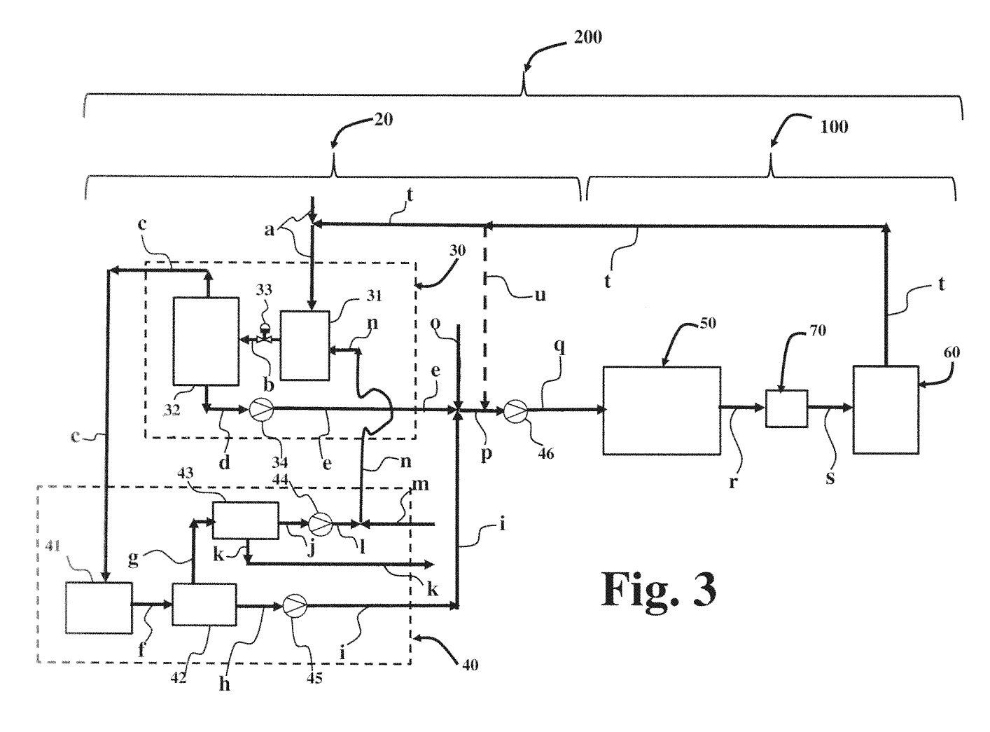

A schematic flow diagram of one specific embodiment of a two-stage process of the present invention 200 is shown in FIG. 3 which combines an H₂ removal process 20 with a solar plant process 100. The H₂ removal process 20 can include for example a flash drum process as stage 30. With reference to FIG. 3, there is shown stage 30 which can be realized by a mixer 31, such as a static mixer 31, and a flash drum 32. As used herein, a “static mixer” includes a device to which different flows are combined and mixed continuously. The static mixer 31 includes internals that direct the flows in a way to achieve high turbulences for best mixing. Inert gas stream (n) flowing from stage 40 and HACL stream (a) can be blended for example in a static mixer 31 before the mixed streams enter the flash drum 32 as mixed stream (b). In addition, the pressure of the inert gas/HACL feed stream (b) to the flash drum 32 can be reduced when the feed stream (b) enters the flash drum 32. This operation results in a separation of liquid and gas phase in the flash drum 32. The consequence of this operation is that dissolved H₂ from the HACL feed stream (a) can be transferred to the vapor phase inert gas stream (n) and the gas stream containing H₂ exits the flash drum as H₂-rich gas stream (c). The HACL stream (d) that leaves the flash drum 32 near the bottom of the flash drum 32 contains a second H₂ concentration that is lower than the initial or first H₂ concentration of the HACL feed stream (a).

The HACL feed stream (a) that is rich in H₂ enters the mixer 31 where a vapor stream (n) that is rich in inert gas and provided from stage 40 is blended with the HACL feed stream (a). The pressure of the resulting vapor/liquid blend in the mixer 31 is then released via a flash control valve 33 before the blended stream (b) enters the flash drum 32 where the vapor and the liquid phase are separated. As used herein, a “flash control valve” includes a valve that controls the flow rate and the pressure of the HACL that enters a flash drum.

The pressure reduction and the contact of the vapor phase with the liquid phase moves dissolved H₂ from the liquid phase to the vapor phase. HACL of reduced H₂ concentration leaves the flash drum 32 via stream (d) and the pressure of stream (d) can be increased via a pressure recovery pump 34 forming stream (e) which leaves stage 30 via the stream (e). Although FIG. 3 shows a pressure recovery pump 34, pump 34 is optional and may not be needed in the stage 30 process; particularly in an embodiment wherein the pressure increase from pump 34 can be performed by a main HACL pump 46 which provides the feed stream (q) to the solar collector field 50. As used herein, a “main HACL (e.g., DPO/BP) pump” includes one or several pumps that circulate HACL over the equipment of a solar plant that can be for example a solar collector field 50 that feeds HACL to a user such as a power block 60 via a piping system 70 which includes several heat exchangers that may belong to the power block and/or a TES system. As used herein, a “pressure recovery pump” includes a pump that brings a liquid discharge of the flash drum 32 to an operating pressure similar to HACL feed stream (a) to stage 30 of the present invention stream. A fresh or makeup HACL stream (o), a recovered HACL stream (i) from stage 40, a portion of stream (t), and/or any other HACLs lost in stage 40 can be optionally added to, or combined with, stream (e) of stage 30 to form stream (p). Stream (p), which is charged via the main HACL pump 46, becomes the feed for the solar plant 100 which is introduced into solar field 50. Optionally, the HACL makeup stream (o) may be added to one or more various streams in the overall process such as stream (a), (e), (i), (p) or (q).

With reference to stage 40, the vapor outlet stream (c) from the flash drum 32 can enter a vent cooler 41 (as part of stage 40) to partially or completely condense the evaporated HACLs in stream (c). As used herein, a “vent cooler” includes one or more heat exchangers that cool a vapor process stream. Any gases or liquids such as air or water can be used on the non-process side of the heat exchanger to deliver the cooling capacity. The condensed HACLs stream (f) can then be processed through a vent knock out pot 42 where the HACLs can be separated from the vapors in the pot 42. The separated HACLs from the knock out pot 42 can then flow from the pot 42 as stream (h) and passed through a recovery return pump 45 and exits the pump 45 as stream (i). The stream (i) can be charged to stream (e) via the HACL recovery return pump 45. As used herein a “HACL (e.g. DPO/BP) recovery return pump” includes a pump that may be responsible to increase the pressure of recovered fluid and charge the fluid back to a main loop of a process.

The vapor phase stream (g) that leaves the vent knock out pot 42 can be charged, via vapor stream (g), to the H₂ vapor separation unit 43 to remove H₂ from the vapor phase stream (g). The vapor separation unit 43 can be selected from various separators including, for example, (1) an absorption (chemisorption) process; (2) an adsorption process; (3) a catalytic oxidation unit; (4) a membrane process; (5) a proton exchange membrane; and (6) a combination thereof.

The H₂-poor vapor stream (j) leaving the H₂ vapor separation unit 43 can be pressured, via a blower 44, to a pressure in stream (l) matching the pressure of stream (a); and optionally, an inert gas makeup stream, via stream (m), may be added to the pressurized H₂-poor vapor stream (l) before the mixed streams leave stage 40 as stream (n) and before stream (n) can be charged to the mixer 31 of stage 30. As used herein, a “blower” is understood to include a machine that increases the pressure of a vapor stream. This pressure increase may be typically <about 0.5 bar in one embodiment, and can be up to about 5 bar in another embodiment. Although not shown in FIG. 3, the inert gas makeup stream (m) may be optionally charged to the vapor stream (g) before the vapor stream (g) enters the H₂ vapor separation unit 43 or to stream (j) before the stream (j) enters the blower 44.

In one embodiment, the vapor separation unit 43 can be a membrane H₂ vapor separation process. As used herein, a “membrane H₂ vapor separation” includes a unit that comprises a specially designed membrane which allows only certain molecules such as H₂ to pass through the membrane, while the other molecules stay on the other side of the membrane. Membrane materials such a palladium, certain ceramics or polymers can be predetermined to allow only H₂ to pass through a membrane with a lower rate of other molecules.

The vapor phase stream (g) that leaves the vent knock out pot 42 contains mainly inert gas and the removed H₂, but the vapor phase stream (g) may also optionally contain light contaminants or HACL degradation products that may result from being stripped out in the flash drum 32. Optionally, a portion of the vapor phase via stream (g) that leaves the vent knock out pot 42 can be removed via another side stream (not shown) from stream (g). Depending on the type of H₂ vapor separation unit 43 used in the present invention process, such as a membrane unit, a waste stream (k) optionally can exit the H₂ vapor separation unit 43. In another embodiment, another vapor stream (not shown) can be combined with vapor stream (g) which passes through the separation unit 43.

As used herein, a “waste stream” includes the products that are separated from, for example, the stream (g). The waste stream (k) ideally contains only H₂, but as the separation unit 43 may not work at 100% efficiency, the waste stream (k) may also contain other components such as inert gas, HACL, degradation products of the HACL or other contaminants of stream (g). The ratio of the other components to H₂ may be significantly smaller in the waste stream (k) than in stream (g).

Then, waste stream (k) can be used to remove the contaminants and degradation products of the HACL from the overall loop via stream (k). In another embodiment, a gas treatment unit, not shown, can be added to the present process and connected to stream (g) or stream (k) to separate components that are not allowed to be released to the atmosphere.

In the embodiment shown in FIG. 3, stream (t) from user 60 flows to the feed stream (a) entering stage 30. In another optional embodiment, a portion of stream (t), via stream (u) (shown as dotted line (u) in FIG. 3) may be passed to stream (p); and streams (u) and (p) together are fed to pump 46 and exit the pump 46 as stream (q). Although not shown in FIG. 3, in still another optional embodiment, only a portion of stream (t) may be sent to stream (a) and the remainder of stream (t) may be sent to another processing unit. In yet another embodiment not shown in FIG. 3, a portion or all of stream (t) may be combined with stream (b) to form stream (p). In even still another optional embodiment, all of stream (t) may be sent to another processing unit (not shown).

The above process system applied to a PT CSP plant has been simulated and the results of the simulation are shown in the Examples of the present disclosure herein.

In one embodiment, stage 30 may utilize a gas stripper column that may contain one or more stages. In general, stripping is a method using a stripping gas to remove dissolved gases or volatiles from a liquid stream. An example where H₂ is stripped from a liquid stream with an inert gas, such as nitrogen, is described in U.S. Pat. No. 6,550,252 B2.

The function of stripping can be done in a packed, trayed or bubble column. In one embodiment, the stripping gas enters the column at near the bottom and liquid feed enters the column at near the top. In this column the flow of the streams is counter current. Near the middle of the counter-current column, may be disposed packing material or trays over which gas and liquid are charged to maximize the contact between both the gas and liquid streams. In the counter current column, liquid feed can be distributed over the packing or trays at near the top of the column.

The liquid feed, which contains the gas or volatiles to be separated flows down over the packing or trays while the stripping gas flows upwards. Due to the contact of both streams, the volatiles or gases from the liquid feed go to the stripping gas and can be carried out at the top of the column. The liquid stream leaves the column with reduced volatiles or gases at near the bottom of the column. In a co-current column, both the vapor and liquid feeds enter at the same end of the column and exit at the opposite end. The stripping operation can be performed with or without heat input.

The stripping process operation can remove H₂ from an HACL such as DPO/BP heat transfer fluid. The reduction of H₂ from the HACL can be as much as less than about 15 ppb. The recovery of the stripping gas via membrane or catalytic oxidation can also be used in the present invention process.

A stripper process to remove H₂ from DPO/BP heat transfer fluid needs an H₂-poor gas for stripping. As aforementioned, this is a challenge for CSP plants for example because those require nitrogen with a purity of 99.99% which can be supplied by trucks. If the used gas could be regenerated, the costs of delivery and provision of pure N₂ could be minimized. The present invention includes a combination of stages to remove H₂ from the liquid and gas phase to regenerate the gas that is required for stripping and to minimize the requirement for makeup gas.

The use of stripping without gas regeneration in CSP would require a higher purity of inert gas than stripping with gas regeneration because more impurities from the inert gas would come in contact with the HACL, if the inert gas would not be regenerated and reused. More impurities in the HACL can result in accelerated thermal degradation of the HACL in CSP plants. The use of stage 40 in the present invention allows the recovery of the inert gas and minimizes makeup of inert gas and HACL that leave stage 30 in the vapor phase. The reduced demand of inert gas and HACL reduces cost.

Use of a stripper works well to transfer H₂ from a liquid phase to a gas phase. Prior known processes aim to recover H₂; and hence, the gas stream (c) flowing from a stripper should have a H₂ concentration that is as high as possible. And, the remaining concentration H₂ in the liquid stream (e) is of secondary importance. The present invention process, on the other hand, has the primary goal of minimizing the concentration of H₂ in the liquid stripper outlet stream (e), while the concentration of the H₂ rich gas stream that leaves the stripper (c) is not important.

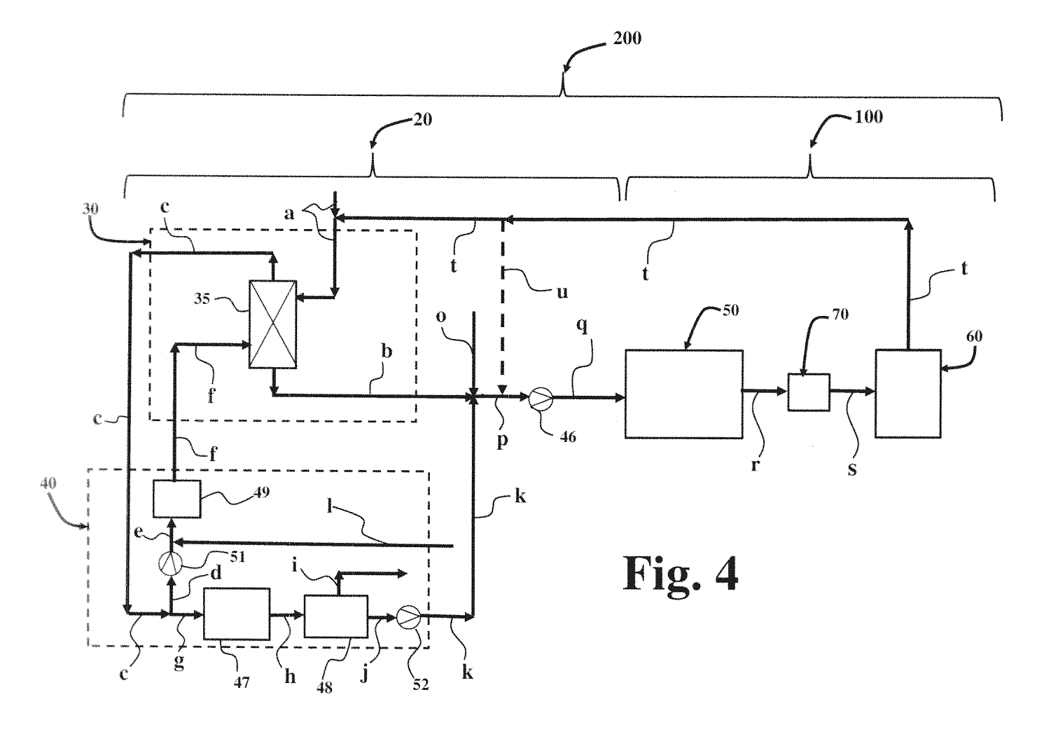

A schematic flow diagram of another embodiment of a two-stage process of the present invention is shown in FIG. 4 where a process using a stripper column is illustrated. With reference to FIG. 4, there is shown stage 30 including a stripper 35. In this embodiment, a HACL feed stream (a) that is rich in H₂ enters the stripper 35 at the top moving toward the bottom of the stripper 35 while an inert gas rich gas stream (f) leaving stage 40 enters at the bottom of the stripper 35 and moves toward the top of the stripper 35. The internals of the stripper 35 ensure a maximum contact between both flows of streams (a) and (f) that allow the H₂ from the HACL (a) to transfer to the vapor stream (c) exiting the stripper 35. The H₂ concentration of the liquid phase stream (a) can be reduced over the height of the stripper 35 from the top of the stripper 35 downwards to the bottom of the stripper 35. The H₂-rich vapor flow leaves the stripper 35 at the top forming stream (c) and the H₂-poor HACL stream leaves the stripper 35 at the bottom forming stream (b). The HACL stream that exits at the bottom of the stripper 35 stream (b) has a lower H₂ concentration than stream (a).

The vapor stream (c) that leaves the stripper 35 at near the top is charged to stage 40 where a blower 51 increases the pressure of stream (c) to mitigate the pressure drop of H₂ vapor separator 49 and stripper 35. The pressurized stream leaving the blower 51 is charged to a separator unit 49 to remove H₂ from the vapor phase. The vapor separation unit 49 can be selected from various separators including, for example, (1) an absorption (chemisorption) process, (2) an adsorption process, (3) a catalytic oxidation unit, (4) a membrane process, (5) a proton exchange membrane, and (6) a combination thereof. Although not shown in FIG. 4 and depending of the type of H₂ vapor separation unit 49 used in the present invention process, such as a membrane unit, a waste stream (not shown) can exit the H₂ vapor separation unit 49.

For example, in one optional embodiment, an absorber unit (not shown) can be placed in any H₂ containing vapor stream. An absorber unit functions well in the present invention process because certain reactive materials, such as zirconium, react with H₂ and form a hydride; and H₂ from a vapor phase can be bonded to these reactive materials. The reactive material can also be recovered by heating the material wherein the heat releases the H₂ from the reactive material. These reactive materials can also be used as getter material inside the annulus vacuum space of a solar receiver to bond H₂ permeating through the walls of a solar receiver steel tube; and thus preserve the vacuum.

When an absorber unit is used, the reactive materials can be placed in multiple vessels or devices. For continuous operation, for example, one or multiple vessels or devices can be in operation while reactive materials of other absorber units are being regenerated. Because the processes utilizing an absorber unit can work well for H₂ in vapor phase streams, absorber units can be used in stage 40 of the present invention. The absorber unit is not a replacement for the present invention until an adsorption material exists that is able to reduce the H₂ concentration in a liquid phase below 15 ppb. However, the absorber unit can optionally be used as ancillary equipment in the present invention. The desorption process to regenerate saturated absorber material should be carried out at temperatures of greater than (>) 400° C. to operate efficiently. In CSP plants, an HTF can reach a maximum temperature of about 400° C.; and thus, the energy for the desorption process may not be provided by the solar field directly alone. Therefore, electricity or fossil fuel can be used to provide the energy for the desorption process.

In another optional embodiment, for example, a catalytic reaction of H₂ with a reactant, such as oxygen (O₂) can be used in the present invention process. For example, there are catalytic effective materials that trigger the reaction of 2H₂+O₂->2H₂O as soon as the catalytic effective materials (catalysts) are in contact with both H₂ and O₂. The catalyst can be placed in a containment vessel and a vapor flow can be charged through the containment vessel. The catalyst has a structure to maximize its catalytic surface to allow maximum catalyst vapor contact. The catalyst can also be placed at the surface of a structured material such as a nanoparticle coating. Examples of H₂ reactive catalysts are described, for example, in JP03969030B2, JP2013015398A (SnO₂ catalyst), JP2000342969A (platinum and palladium based) and EP467110B1.

One important feature of using catalytic effective materials is the selectivity of the catalyst; and side reaction of other components can be minimized. The selectivity and efficiency of catalyst can vary with temperature and pressure. H₂ reactive catalysts have not been reported to work if the H₂ is dissolved in a liquid phase and this liquid phase is in contact with the catalyst. While the use of catalytic effective materials, alone, may not fulfill the requirements in a CSP plant, the catalyst method can optionally be used to complement the present invention.

Still another optional embodiment useful in the present invention can include, for example, the use of a membrane selective to H₂. Because H₂ is able to permeate through different solid materials such as steel, this permeable phenomenon can be used to separate H₂ from a specific flow stream. There are various different membrane options to use. For a CSP application, one suitable material that is very effective is palladium. Palladium is able to resist high temperatures (e.g. up to 400° C.) that are used in CSP plants. A palladium membrane operates via pressure driven diffusion across the palladium membrane; and only H₂ can diffuse through the palladium membrane. The palladium membrane can take a number of forms, including an array of tubes, a coiled tube, membrane foil, or a combination thereof. The membrane may include a combination of materials, for example, a palladium and silver alloy material possessing a unique property of only allowing monatomic H₂ to pass through the alloy's crystal lattice when the alloy material is heated above nominally 300° C. The H₂ gas molecule coming into contact with the palladium membrane surface can dissociate into monatomic H and can then pass through the membrane. On the other surface (opposite side) of the palladium membrane, the monatomic H can recombine into diatomic H₂.

The above optional membrane selectivity method can be applied in solar receivers. If H₂ that is dissolved in the HTF permeates through the steel wall of the receiver steel tube or pipe and enters the annulus space, H₂ would directly be carried out of the annulus space via the membrane that builds a border between the annulus space and the atmosphere.

With reference to FIG. 4 again, there is shown a H₂-poor vapor stream leaving the H₂ vapor separation unit 49 from stage 40 via stream (f) and the H₂-poor vapor stream (f) is charged to the bottom of the stripper 35 in stage 30. Inert gas makeup can be added to the vapor stream via stream (l) before the vapor stream leaves stage 40 as stream (f). Stream (l) can be added to the vapor stream (f) before the blower 51 in stream (d) (not shown), after the blower 51 in stream (e) as shown in FIG. 4, or after the vapor separation unit 49 in stream (f) (not shown).

With reference to stage 40, a portion or the complete stream (c) may also be condensed and introduced into a knock out pot where HACLs can be partially or completely separated from the gas stream (c). As used herein, a “vent knock out pot” includes a knock out pot that is used for separating less volatile components such as DPO/BP from a vent vapor stream. The gas stream (f) returning to stage 30 may contain HACL vapors that are not separated in stage 40.

With reference to stage 40, a portion of the vapor phase stripper outlet stream (c) can enter a vent cooler 47, via stream (g), as part of stage 40 which condenses the evaporated HACLs from stream (g) into stream (h). The stream (h) can then be charged to a vent knock out pot 48 where the HACLs can be separated. The separated HACL stream (j) can then be passed through recovery return pump 52 which charges the separated HACL stream (k) to stream (b).

The gas stream output of the knock out pot 48 exits the loop via stream (i). In an optional embodiment, a gas treatment unit (not shown) can be connected in fluid communication to stream (i) to separate components from stream (i) that may not be allowed to be released to the atmosphere.

In one embodiment as shown in FIG. 4, the recovered HACL stream (k), a makeup HACL stream (o), and stream (b) from stripper 35 can be blended together to from stream (p) flowing through the main HACL pump 46 to form feed stream (q). Stream (q) becomes the feed stream to the solar plant 100 by passing stream (q) to the solar field 50. In another optional embodiment, the HACL makeup stream, via stream (o), may be added to stream (b) at a point of stream (b) to form stream (p) which may be passed through pump 46 and provide a feed stream (q) to the solar field 50. In other optional embodiments, the HACL makeup stream (o) may be added to stream (a), stream (b), stream (f), stream (k), stream (p), stream (q), or any combination thereof.

In the embodiment shown in FIG. 4, stream (t) from user 60 flows to the feed stream (a) entering stage 30. In another optional embodiment, a portion of stream (t), via stream (u) (shown as dotted line (u) in FIG. 4) may be passed to stream (p); and streams (u) and (p) together are fed to pump 46 and exit the pump 46 as stream (q). Although not shown in FIG. 4, in still another optional embodiment, only a portion of stream (t) may be sent to stream (a) and the remainder of stream (t) may be sent to another processing unit. In yet another embodiment not shown in FIG. 4, a portion or all of stream (t) may be combined with stream (b) to form stream (p). In even still another optional embodiment, all of stream (t) may be sent to another processing unit (not shown).

The above process system applied to a PT CSP plant has been simulated and the results of the simulation are shown in the Examples of the present disclosure herein.

The present invention process of removing H₂ from a HACL has several benefits including for example: (1) the process is able to operate at temperatures of greater than the minimum temperature of the HTF coming from users during operation which is about 290° C.; (2) the process is able to operate at pressures of greater than the minimum pressure of the HTF which is at about 11 bara; (3) the H₂ rich gas stream of the present invention extracted from this HTF stream via N₂ stripping is typically also at temperatures around 290° C., but the H₂ rich gas stream does not need to be cooled before the extracted gas can pass through the stripping or other equipment for separating H₂; and (4) the present process does not require cooling which takes energy from the HTF and reduces the energy available for electricity production. The present invention process (stripper and catalytic oxidation) can be operated at 300° C. process conditions. The energy required to be taken from the HTF cycle is minimized to bring HACL and inert gas makeup to process temperatures and pressures. As the process of the present invention minimizes the amount of HACL and inert gas makeup, savings are achieved in both cost of HACL and inert gas makeup and energy demand to bring them to process conditions.

The present invention process is advantageously used in a solar field and specifically in a solar receiver. The service life of the solar receiver can be extended using the present invention process. In addition to the use of the present invention process in a PT CSP, the inventive process can also be used in any chemical or petrochemical process, for which a HACL having a low H₂ level is required.

### EXAMPLES

The following Examples and Comparative Example further illustrate the present invention in more detail but are not to be construed to limit the scope thereof.

Examples 1 and 2 are examples of the present invention. Comparative Example A is a comparative example in which inert gas is not recovered.

In the following Examples and Comparative Example, Dowtherm™ A was used as the HACL. Dowtherm™ A is a HACL commercially available from The Dow Chemical Company. Dowtherm™ A consists of 73.5% diphenyl oxide and 26.5% biphenyl. The purity of Dowtherm™ A is about 99.9%.

The simulations performed in Examples 1 and 2 and Comparative Example A were generated using ASPEN™ PLUS version 8.6.

Example 1 uses a static mixer 31 and a flash drum 32 for stage 30 and a knock out pot 42 and a membrane gas separator unit 43 for stage 40.

Example 2 uses as stripper 35 for stage 30 and a knock out pot 48 and a catalytic oxidation unit 49 for stage 40.

In Comparative Example A, a stripper is used for stage 30 like in Example 2, but only a knock out pot is used for stage 40.

### Assumptions for the Examples

The following assumptions are made for the Examples described herein below:

A blend of 73.5% diphenyl oxide (DPO) and 26.5% biphenyl (BP) is used as HACL, which is herein designated as DPO/BP fluid.

The thermal degradation rate for a DPO/BP purity of 99.9% is assumed based on a report published by C. Lang, Heat Transfer Fluid life time analysis of Diphenyl oxide/Biphenyl grades for Concentrated Solar Power Plants, SolarPaces 2014, Beijing. The H₂ generation rate is assumed based on the thermal degradation rate of the DPO/BP purity of 99.9%

The ASPEN™ PLUS simulation is performed based on DOWTHERM™ A heat transfer fluid which is a blend of 73.5% DPO and 23.5% BP. Physical and thermodynamic properties of components used (N₂, H₂, H₂O, DPO, and BP) in the simulation were obtained from ASPEN PLUS material database. The degradation reaction of DPO/BP is simplified as follows: any H₂ that is formed in solar field 50 and hot header 70 reduces the DPO/BP concentration adequately. Other degradation products are ignored and assumed not to exist for the ASPEN™ PLUS simulation.

Nitrogen (N₂) is used as inert gas. The N₂ makeup stream is calculated for each simulated case.

It is assumed that 27.95% of the thermal degradation reactions in the system happen in the solar field 50 and 72.05% in the hot header 70, which is the piping system between solar field 50 and users 60. Hence, 27.95% of the H₂ is formed in the solar field 50 and 72.05% is formed in the hot header 70.

Any losses of H₂ from the overall process loop via permeation are not considered in the simulation.

The liquid gas separation conditions of this simulation are based on the Henry law equations (1) and (2)

p(H₂)=H_{H2}·n_{H2}/n_{DPO/BP} (1)

p(N₂)=H_{N2}·n_{N2}/n_{DPO/BP} (2)

In the equations above, p (H₂) is the partial pressure of H₂ in the vapor phase in Pascal, p (N₂) is the partial pressure of N₂ in the vapor phase in Pascal, H_{H2} is the Henry volatility constant of hydrogen in bar, H_{N2} is the Henry volatility constant of nitrogen in bar, n_{H2}/n_{DPO/BP} is the molar proportion of H₂ versus DPO/BP in the liquid phase.

The Henry's volatility constants for H₂ and N₂ in DPO/BP are described by equations (3) and (4) which are sourced from Ch. Jung from DLR in his presentation “Bestimmung der Wasserstoffkonzentration im organischen Wärmeträger von Parabolrinnenkraftwerken” published on the 12. Kölner Sonnenkolloquium in Jun. 9, 2008.

ln H_{H2}=259.22·1/T+7.3698 (3)

ln H_{N2}=−973·1/T+9.04 (4)

In the equations above, T is the temperature in Kelvin, H_{H2} is Henry's law volatility constant for H₂ in bar and H_{N2} is Henry's law volatility constant for N₂ in bar.

The equation (1, 2, 3, 4) are incorporated into ASPEN™ PLUS uses for this simulation.

The conditions of an assumed CSP plant are shown in Table I. A PT CSP plant is assumed to deliver 50 MW of electricity. The plant has a TES system in which energy from the sun is loaded during the day and is released when the sun power is not sufficient to run the power block. The solar field of the assumed plant is assumed to have a solar field twice as big as required in order to produce 50 MW electricity which is equal to a solar multiple of 2. The thermal power for these conditions is assumed to be 270 MW, which results in a power block heat to electricity efficiency of 37%. The DPO/BP flow rate from Table I is selected to charge this 270 MW thermal power from the solar field to power block and TES system, shown as users 60 in FIGS. 3 and 4, at a temperature difference of 100K between inlet and outlet of the solar field.

ASPEN™ PLUS calculates pump energy for pumps and blowers. For the conversion to the electrical power demand for pumps, the pump energy was divided by 0.7 to receive the electrical energy demand. For the conversion of the electrical energy of a blower, a divisor of 0.6 is assumed.

TABLE I
Physical Properties of PT CSP Plant
Using Simulation of H₂ Removal Unit

| | | Stream/ | |
|---|---|---|---|
| Property | Unit | Equipment | Values |
| Electrical power output of CSP | MW | 60 | 50 |
| Solar multiple | | 50 | 2 |
| Thermal power of solar field | MW | 50 | 270 |
| Yearly operating hours | hours | 200 | 2550 |
| Rotated DPO/BP mass CSP plant | MT | 200 | 1840 |
| Mass flow rate of DPO/BP | MT/hr | p, q (FIG. 3, | 3891.9 |
| | | FIG. 4) | |
| DPO/BP outlet temperature power block | ° C. | a | 293 |
| DPO/BP solar field discharge | ° C. | r, 50 | 393 |
| temperature | | | |
| Portion of H₂ formed in solar field | % | 50 | 27.95 |
| Stripper/flash vessel altitude above main | m | 32, 35 | 20 |
| DPO/BP pump | | | |
| Portion of DPO/BP flow to H₂ removal | % | a/v | 100 |
| unit | | | |

### Example 1—Flash Drum Design (as Part of the Present Invention)

In this Example 1, a flash drum 32 is used for stage 30 (separation of H₂ from liquid DPO/BP; and a H₂ membrane unit is used as H₂ vapor separation equipment 43 as illustrated in FIG. 3.

The low H₂ containing DPO/BP stream (e, p, q) of the unit 32 is charged to a solar collector field 50 via the main DPO/BP pump 46 where its temperature is increased to about 393° C. and the stream (r) from solar field 50 is charged via the hot header 70 and stream (s) is charged to the power block and TES system 60 where the temperature is decreased back to about 293° C. again. During the journey to the power block and TES system 60, the stream (q, r, s) increases in H₂ concentration. 27.95% of the H₂ is assumed to be formed in the solar collector field 50 and 72.05% of the H₂ is assumed to be formed in the hot header 70. This ratio has been determined based on the temperature profile and retention time of the DPO/BP in the solar collector field 50 and the hot header 70. Because the H₂ permeation through equipment is ignored in this simulation, the concentration in stream (a) is assumed to be the same as in stream (s).

In the power block 60, the energy from the DPO/BP evaporates condensate resulting in steam that may drive, for example, a turbine and a generator that produces electricity. In the TES system, the energy of the DPO/BP is transferred to a storage medium with the purpose of charging the energy back to the DPO/BP when not enough energy is available from the solar field to run the power block.

The liquid DPO/BP feed stream (a) that is rich in H₂ enters a mixer 31 where a vapor stream (n) from stage 40 that is rich of N₂ is blended with. The pressure of this vapor liquid mixture is then partially released via control valve 33 before the stream enters the flash drum 32 where vapor and liquid phase are separated. The pressure reduction and the contact of vapor with liquid phase moves dissolved H₂ from the liquid to the vapor phase. Liquid DPO/BP of reduced H₂ concentration leaves the flash drum 32 and the pressure of the stream is increased via the pressure recovery pump 34 from where it leaves stage 30 via stream (e). The recovered DPO/BP stream (i) from stage 40 and that is removed from the system in stage 40; and fresh DPO/BP (stream o) are added to stream (e) from stage 30 to form stream (p).

The vapor outlet of the flash drum 32 (stream c) enters a vent cooler 41 as part of stage 40 in order to condense the evaporated DPO/BP ending up in the knock out pot 42 where most of the liquid DPO/BP is separated from the vapors and charged as stream (i) to stream (e) via the HACL recovery return pump 45.

The vapor phase that leaves the vent knock out pot 42 is then charged as stream (g) to the H₂ vapor separation unit 43 to remove H₂ from the vapor phase. A membrane H₂ separation unit is assumed as H₂ vapor separation 43 in this Example 1. It is assumed that the membrane allows 1% of the flow rate through, which is H₂ with a bit of N₂, and that stream leaves the membrane as stream (k). The H₂ poor vapor stream (j) leaving the H₂ vapor separation unit 43 is pressured to the pressure of stream (a) via the blower 44 and N₂ makeup is added to the stream via stream (m) before it leaves stage 40 as stream (n) and is charged to the mixer 31 of stage 30.

The vapor phase that leaves the vent knock out pot 42 contains mainly N₂ and the removed H₂, but it may also contain light contaminants or degradation products from the DPO/BP that is also stripped out in the flash drum 32. Stream (k) can be charged to a gas treatment unit (not shown) that separates components that are not allowed to be released to the atmosphere.

### Baseline for the Simulation of Example 1

The input values for the cases can be seen in Table II.

Stage 30 consists of a static mixer 31 and a control valve 33 is installed at the outlet of the static mixer 31 from where the stream (a, b) ends up in a flash drum 32.

A membrane separation unit 43 is used in stage 40 for H₂ vapor separation.

The H₂ removal unit 20 is integrated to a PT CSP plant which is shown in FIG. 3.

A DPO/BP makeup stream (o) of 33 lb/h (15.0 kg/h) is considered to be introduced to the loop permanently.

The H₂ forming rate in for the plant is 35.1 g/h.

The N₂ makeup stream (m) has been minimized for the simulated case. Pure N₂ at 100% purity has been assumed.

The membrane separation unit 43 is assumed to split the inlet flow in a H₂ rich flow which is 1% of inlet flow and a H₂ poor flow that is 99% of the inflow that contains just 13.59 ppb of H₂.

The membrane separation unit 43 is assumed to have 0.5 bar pressure drop

The flash drum 32 is selected to be on an altitude of 20 meters above the solar field 50 and the hot header 70. This allows a lower pressure in the flash drum 32. The lower flash drum pressure increases the H₂ rate that is transferred from the DPO/BP stream (a) to the vapor stream (c). Furthermore the concentration of N₂ in the liquid DPO/BP flash drum outlet (d) is lower at lower flash drum pressure. The pressure of the DPO/BP in the solar field 50 and the header 70 is higher than in the flash drum 32 which increases the solubility of N₂ in the DPO/BP in the solar field 50 and in the header 70. The solubility of N₂ in the DPO/BP reduces with elevated temperatures. If too much N₂ is dissolved in the DPO/BP, the N₂ can separate from the liquid DPO/BP where the temperature is high like in the solar field 50 and in the header 70. Gaseous N₂ in the solar field and header can cause cavitation and wear of the pipe walls. So if the flash drum 32 is installed at a higher altitude than the solar field 50, the DPO/BP has more capacity to dissolve N₂ when it enters the solar field 50. If the temperature is increased in the solar field 50 and the solubility of N₂ decreases, the DPO/BP fluid is not as close at the solubility limit as if the flash drum 32 would be at lower altitude.

The flash drum 32 is considered not to have a pressure drop.

The required solar power from the solar field for the heat demand of the process=

Cooling energy from heat exchanger 41−blower 44 power−pump power 34, 45.

The required solar power from solar field for the operation of the additional pumps 34, 45 and blower 44=[(pump 34 power+pump 45 power)/0.7+blower 44 power/0.6]/0.37.

Portion of thermal consumption of unit from thermal power available from solar field=(the required solar power from the solar field for the heat demand of the process+the required solar power from solar field for additional pumps and blower)/270000 kW*100.

Portion of electrical power consumption of unit from total electrical power produced=(blower 44 power+pump 34 power+pump 45 power+portion of thermal consumption of unit from thermal power available from solar field*0.37)/50000 kW*100.

TABLE II
Input/Output Values of ASPEN ™ PLUS Simulation of Inventive Process

| | | | Stream and/or | |
|---|---|---|---|---|
| | Property | Unit | Equipment | Values |
| Input | H₂ generation rate in solar field | g/hr | 50 | 9.810 |
| | H₂ generation rate in hot piping system | g/hr | 70 | 25.290 |
| | H₂ rich stream leaving the membrane | kg/hr | j, 43 | 0.136 |
| | H₂ conc. at the exit of solar field | ppb | r, 50 | 3.48 |
| | H₂ conc. at the exit of membrane system | ppb | j, 43 | 13.59 |
| Output | DPO/BP concentration in vapor feed stream | % wt. | n | 0.0078 |
| | to stage 30 | | | |
| | DPO/BP makeup rate during operation | kg/hr | o | 15.0 |
| | N₂ makeup rate during operation | kg/hr | m | 136.0 |
| | Blower flow rate | kg/hr | l | 13589 |
| | Blower power | kW | 44 | 274 |
| | Additional pump power | kW | 34 & 45 | 809 |
| | Required solar power from solar field for | kW | 20 | −1075 |
| | the heat demand of the process | | | |
| | Required solar power from solar field for | kW | 20 | 4356 |
| | the operation of the additional pumps 34, | | | |
| | 45 and blower 44 | | | |
| | Portion of thermal consumption of unit from | % wt. | 20 | 1.21 |
| | thermal power available from solar field | | | |
| | Portion of electrical power consumption of | % wt. | 20 | 1.37 |
| | unit from total electrical power produced | | | |

TABLE III
Results Summary

| | | Stream/ | |
|---|---|---|---|
| Property | Unit | Equipment | Values |
| H₂ conc. at the exit of solar field | ppb | r, 50 | 3.5 |
| Operation temperature of stage 30 outlet | ° C. | c, 32 | 291.8 |
| Operating pressure of stage 30 outlet | bara | c, 32 | 7.5 |
| Portion of thermal consumption of unit from | % | 20 | 1.21 |
| thermal power available from solar field | | | |
| N₂ makeup rate during operation per MT | kg/h | m | 0.188 |
| circulated DPO/BP | | | |

The results are recorded in Table II and III above. Table III summarizes specific results for the present invention. A H₂ concentration below 10 ppb at the exit stream (r) of the solar field 50 could be reached with the selected process. The makeup rates for N₂ stream (m) and the blower flow rate (l) are minimized to values corresponding to where the ASPEN simulation would no longer converge using standard error tolerances. The final values also depend on system losses and what is necessary to purge impurities in the stripping gas recycle loop.

The fact that the required solar power from the solar field for the heat demand of the process is a negative number means that blower 44 and pumps 34 and 45 provide more thermal energy to the DPO/BP loop than heat energy that is removed from the loop via cooling of vent streams via heat exchanger 41, evaporation of DPO/BP in flash vessel 32, and by the addition of cold makeup streams (m, o). This means that a part of the pump energy can be reused to be charged to the users 60.

### Example 2—Simulation of H₂ Removal Unit for PT CSP Plant Based on N₂ Stripper and Catalytic Oxidation

In this Example 2, a stripper 35 is used for stage 30 (separation of H₂ from liquid DPO/BP; and a H₂ catalytic oxidation unit is used as H₂ vapor separation equipment 49 as illustrated in FIG. 4.

The low H₂ containing DPO/BP stream (q) is charged to a solar collector field 50 via the main HTF pump 46 where its temperature is increased from about 293° C. to about 393° C. and the stream (r, s) is then charged via the hot header 70 to power block and TES system 60 where the temperature is decreased back to about 293° C. again. During this journey to the power block and TES system 60, the stream (q) increases in H₂ concentration. 27.95% of the H₂ is assumed to be formed in the solar collector field 50 and 72.05% of the H₂ in the hot header 70. This ratio has been determined based on the temperature profile and retention time of the DPO/BP in the solar collector field 50 and the hot header 70. Because the H₂ permeation through equipment is ignored in this simulation, the concentration in stream (a) is assumed to be the same as in stream (s).

In the power block 60, the energy from the DPO/BP evaporates condensate resulting in steam that drives a turbine and a generator that produces electricity. In the TES, the energy of the DPO/BP is transferred to a storage medium with the purpose of charging the energy back to the DPO/BP when not enough energy is available from the solar field to run the power block.

The liquid DPO/BP feed stream (a) that is rich in H₂ enters the stripper 35 which is used as stage 30 where H₂ is taken from the liquid phase. The liquid DPO/BP feed stream (a) exits the stripper 35 as stream (b) with a reduced H₂ concentration. The recovered DPO/BP stream (k) from stage 40 and fresh DPO/BP stream (o) are added to stream (b) from stage 30 to replenish DPO/BP stream that is lost in stage 40 and to form stream (m) which then enters the DPO/BP pump 46 that charges the DPO/BP stream back to the solar field 50 via stream (q).

The recovered vapor stream (f) from stage 40 which contains N₂, DPO/BP vapor and which is poor of H₂ enters the stripper 35 where stream (f) picks up H₂ from stream (a) and leaves the stripper as stream (c). The vapor phase stream (c) that leaves the stripper 35 is charged to stage 40 where stream (c) enters the H₂ vapor separation unit 49 via stream (e) to remove H₂ from the vapor phase. A catalytic oxidation unit is assumed as H₂ vapor separation 49 in this Example 2. N₂ makeup (l) containing oxygen (O₂) is blended to the stream before the stream enters the catalytic oxidation unit 49 via stream (e). The catalyst of the catalytic oxidation unit converts the H₂ with the O₂ of the makeup stream (l) to water (H₂O) that leaves the catalytic oxidation unit 49 as stream (f) which goes to the stripper 35 as described above.

A blower 51 is installed in the loop: stripper vapor outlet (c) to catalytic oxidation 49 and back to vapor inlet of stripper 35. The blower 51 ensures the cycling of the vapor stream by making up the pressure drop of pipes, catalytic oxidation 49 and stripper 35.

A portion of the vapor stripper outlet stream (c) that enters stage 40 is split as stream (g) and is passed to the heat exchanger 47 where a portion of the DPO/BP vapors are condensed. The stream (h) is charged to the knock out pot 48 where the stream (h) is split to a vapor stream (i) and a liquid stream (j). The vapor stream (i) that leaves the vent knock out pot 48 contains mainly N₂ and H₂, but the stream (i) may also contain light contaminants or degradation products from the DPO/BP that optionally may also be stripped out in the stripper 35. Optionally, a gas treatment unit (not shown) could be connected to stream (i) in order to separate the components before stream (i) is released to the atmosphere.

The liquid phase stream (j) that leaves the knock out pot 48 is charged back to the solar loop stream (b) via pump 52 as stream (k).

### Baseline for the Simulation of Example 2

Stage 30 consists of a gas stripper 35 that contains 3 stages.

A catalytic oxidation unit 49 is used in stage 40 for H₂ vapor separation.

The H₂ removal unit 20 is integrated to a PT CSP plant 100.

A DPO/BP makeup stream (o) of 10 lb/hr (4.53592 kg/hr) is considered to be introduced to the solar loop stream (b) permanently.

The N₂ makeup stream has been calculated for each simulated case. A H₂ content of 1 ppb in the makeup stream is assumed. Another considered impurity of the N₂ is oxygen. In the simulated cases, only so much O₂ is assumed to be in the makeup stream that can be reacted with the H₂ that enters the catalytic oxidation unit 49.

It is assumed that all oxygen that enters the catalytic oxidation unit 49 is reacted there in the unit 49 with the H₂ to form H₂O. For this reason, O₂ presence is ignored at stripper simulation, but the Henry law is applied for H₂O separation in the stripper 35. Unlike O₂, it is assumed that some H₂ is not reacted.

The consideration and the presence of other degradation products than H₂ are ignored. The simulation in this Example 2 assumes any mass of H₂ that is formed from results in a deduction of the same mass of DPO/BP.

The separation characteristics of the H₂O in the DPO/BP are calculated by the Henry's law volatility constants H_{H2O} for H₂O in the DPO/BP based on the following Equation (5):

p(H₂O)=H_{H2O}·n_{H2O}/n_{DPO/BP} (5)

In Equation (5) above, p (H₂O) is the partial pressure of H₂O in the vapor phase in Pascal, H_{H2O} is the Henry volatility constant of water in bar and n_{H2O}/n_{DPO/BP} is the molar proportion of H₂O versus DPO/BP in the liquid phase.

The Henry's volatility constants for H₂O in DPO/BP are described by the following Equation (6):

ln H_{H2O}=−1680.4·1/T+7.492 (6)

In Equation (6) above, T is temperature in Kelvin and H_{H2O} is Henry's law volatility constant for H₂O in DPO/BP in bar.

The stripper 35 liquid inlet (a) is selected to be on an altitude of 20 meters above the solar field 50 and the hot header 70. This allows a lower pressure in the stripper 35. The lower stripper pressure increases the H₂ rate that is transferred from the DPO/BP stream (a) to the vapor stream (c). Furthermore, the concentration of N₂ in the liquid DPO/BP stripper outlet (b) is lower at lower stripper pressure. The pressure of the DPO/BP in the solar field 50 and the header 70 is higher than in the stripper 35 which increases the solubility of N₂ in the DPO/BP in the solar field 50 and in the header 70. The solubility of N₂ in the DPO/BP reduces with elevated temperatures. If too much N₂ is dissolved in the DPO/BP, the N₂ can separate from the liquid DPO/BP where the temperature is high like in the solar field 50 and in the header 70. Gaseous N₂ in the solar field 50 and header 70 can cause cavitation and wear of the pipe walls. Thus, if the stripper 35 is installed at a higher altitude than the solar field 50, the DPO/BP has more capacity to dissolve N₂ when the liquid DPO/BP stream (q) enters the solar field 50. If the temperature is increased in the solar field 50 and the solubility of N₂ decreases, the DPO/BP fluid is not as close at the solubility limit as if the stripper 35 would be at lower altitude.

The required solar power from solar field 50 for the heat demand of the process=Cooling energy from heat balance of additional equipment 47−blower 51 power−pump power 52.

The required solar power from solar field 50 for additional pumps and blower was calculated to be=[pump 52 power/0.7+blower 51 power/0.6]/0.37.

Portion of thermal consumption of unit from thermal power available from solar field=(The required solar power from solar field for the heat demand of the process+the required solar power from solar field for additional pumps and blower)/270000 kW*100.

Portion of electrical power consumption of unit from total electrical power produced=(blower 51 power+pump (52) power+portion of thermal consumption of unit from thermal power available from solar field*0.37)/50000 kW*100.

### Three Simulation Conditions Used for Example 2

The input values for the following three cases used in this Example 2 are described in Table IV.

Case 1 assumes new DPO/BP based HTF at 99.9% purity for which a H₂ generation rate of 0.66 g/hr in the solar field and 1.702 g/hr in the hot header is assumed.

Cases 2 and 3 assume the same type of HTF, but so much of the HTF ages that the HTF contains 10% degradation products, for which a H₂ generation rate of 2.987 g/hr in the solar field and 7.701 g/hr in the hot header is assumed.

The H₂O generation rate in the catalytic oxidation 49 is manually calculated based on the H₂ that reacts in the catalytic oxidation 49 with O₂ and then the calculation is used as input for the ASPEN™ PLUS simulation.

In cases 1 and 2, the H₂ target concentration at the output of the solar field of 1 ppb which is as low as calculated based on equation (1) and (3) and based on Schott's specification, Brochure: “SCHOTT PTR®70 Receiver 4th generation”, 90604 ENGLISH 11131.0 kn, 2015.

Case 3 simulates the H₂ target concentration at the output of the solar field to be at about 10 ppb.

Different efficiencies have been assumed for the catalytic oxidation unit 49. Cases 1, 2 and 3 assume 1.21 ppb, 1.38 ppb and 10.79 ppb of H₂ at the exit of the catalytic oxidation unit, respectively.

TABLE IV
Input/Output Values of ASPEN ™ PLUS Simulation of the Inventive Process

| | | | Stream/ | Case 1 | Case 2 | Case 3 |
|---|---|---|---|---|---|---|
| | Property | Unit | equipment | Values | Values | Values |
| Input | H₂ generation rate in solar field | g/hr | 50 | 0.660 | 2.987 | 2.987 |
| | H₂ generation rate in hot piping system | g/hr | 70 | 1.702 | 7.701 | 7.701 |
| | H₂O generation rate in catalytic oxidation | g/hr | 49 | 20.848 | 94.319 | 94.301 |
| | H₂ conc. at the exit of solar field | ppb | r, 50 | 0.93 | 1.04 | 9.90 |
| | H₂ conc. at the exit of catalytic oxidation unit | ppb | f, 49 | 1.21 | 1.38 | 10.79 |
| Output | DPO/BP concentration in vapor feed stream to | % wt. | f, 35 | 59.40 | 59.40 | 59.40 |
| | stage 30 | | | | | |
| | DPO/BP makeup rate during operation | kg/hr | o | 4.5 | 4.5 | 4.5 |
| | N₂ makeup rate during operation | kg/hr | l | 12.8 | 49.9 | 6.4 |
| | Blower flow rate | kg/hr | d | 2568 | 9991 | 1273 |
| | Blower power | kW | 51 | 3.93 | 15.29 | 1.95 |
| | Additional pump power | kW | 52 | 0.003 | 0.011 | 0.001 |
| | Required solar power from solar field for heat | kW | 20 | 1.2 | 4.8 | 0.6 |
| | balance of additional equipment | | | | | |
| | Required solar power from solar field for | kW | 20 | 17.7 | 68.9 | 8.8 |
| | additional pump 52 and blower 51 | | | | | |
| | Portion of thermal consumption of unit from | % wt. | 20 | 0.0070 | 0.0273 | 0.0035 |
| | thermal power available from solar field | | | | | |
| | Portion of electrical power consumption of | % wt. | 20 | 0.0088 | 0.0342 | 0.0044 |
| | unit from total electrical power produced | | | | | |

TABLE V
Summary of Output Values of Example 2

| | | Stream/ | | | |
|---|---|---|---|---|---|
| Property | Unit | Equipment | Case 1 | Case 2 | Case 3 |
| H₂ concentration at the exit of solar field | ppb | r, 50 | 0.93 | 1.04 | 9.90 |
| Operation temperature of stage 30 outlet | ° C. | c, 35 | 293 | 293 | 293 |
| Operating pressure of stage 30 outlet | bara | c, 35 | 10.40 | 10.40 | 10.40 |
| Portion of thermal consumption of unit from | % wt. | 20 | 0.0070 | 0.0273 | 0.0035 |
| thermal power available from solar field | | | | | |
| N₂ makeup rate during operation per MT | kg/hr | l | 0.00698 | 0.02712 | 0.00345 |
| circulated DPO/BP | | | | | |

### Results for the Simulation of Example 2

The results for the three cases are shown in Table IV and Table V. The target H₂ concentration at the exit of solar field (stream r) could be reached with the selected process. The makeup rates for N₂ (stream l) and the stripper vapor feed rate (stream f) were not completely optimized for each of the 3 cases. The final value depends on system losses and what is necessary to purge impurities in the stripping gas recycle loop. Further optimization is recommended in order to minimize energy consumption of the process. The following comparative values for makeup demands and energy consumption are just right from an order of magnitude. New DPO/BP (case 1) that generates about 4.5 times less H₂ than used DPO/BP with 10% degradation products, needs about 3.7 times less thermal energy than the used DPO/BP of case 2.

Case 1 also needs about 3.9 times more N₂ makeup.

Case 3 accepts an about 10 times higher H₂ concentration at the exit of the solar field than case 1 and 2. In comparison to case 2, the thermal and electrical energy consumption is about 7.4 times lower and about 7.9 times less N₂ makeup is required.

### Comparative Example A—Simulation of H₂ Removal Unit for PT CSP Plant Based on N₂ Stripper Only

In this Comparative Example A, a process is carried out as described in Example 2 except that a H₂ vapor separation 49 is not part of stage 40 which recovers the inert gas (N₂). Stage 30 in this Comparative Example A removes H₂ as described in Example 2.

A low H₂ containing DPO/BP stream is charged to a solar collector field via a main DPO/BP pump where its temperature is increased from about 293° C. to about 393° C. and the stream is then charged via a hot header to a power block and TES system where the temperature is decreased back to about 293° C. again. During the journey to the power block and TES system, the stream increases in H₂ concentration resulting. 27.95% of the H₂ is assumed to be formed in the solar collector field and 72.05% of the H₂ in the hot header. This ratio is determined based on the temperature profile and retention time of the DPO/BP solar collector field and the hot header. Because the H₂ permeation through equipment is ignored in this simulation, the H₂ concentration at the outlet of the hot header is assumed to be the same as at the entry of the stripper.

In the power block, the energy from the DPO/BP evaporates condensate resulting in steam that drives a turbine and a generator that produces electricity. In the TES, the energy of the DPO/BP is transferred to a storage medium with the purpose of charging the energy back to the DPO/BP when not enough energy is available from the solar field to run the power block.

The liquid DPO/BP feed stream that is rich in H₂ enters then a stripper which is used in stage 30 where H₂ is taken from the liquid phase. The liquid DPO/BP feed stream exits the stripper as an exit stream with a reduced H₂ concentration. The recovered HACL from an HACL recovery unit and a fresh DPO/BP stream is added to the exit stream from stage 30 to form a feed stream which enters a DPO/BP pump that charges the stream back to the solar field.

Fresh N₂ gas enters the stripper via a stream from stage 40 where the gas stream picks up H₂ from the feed HACL stream to the stripper and leaves the stripper as exit vapor stream. The vapor phase stream that leaves the stripper is then charged to the HACL recovery unit, where the HACL is separated from the N₂ stream.

The vapor stripper outlet stream from the stripper is condensed in a heat exchanger and charged into a knock out pot where the outlet stream is split to a vapor stream and a liquid stream. The vapor phase that leaves the vent knock out pot contains mainly N₂ and H₂, but the vapor phase that leaves the knock out pot may also contain light contaminants or degradation products from the DPO/BP that is also stripped out in the stripper. Optionally, a gas treatment unit could be connected to the vapor phase that leaves the vent knock out pot in order to separate the undesirable components before the vapor phase is released to the atmosphere.

The liquid phase stream that leaves the knock out pot as stream is charged back to the solar loop stream leaving the stripper via a pump.

### Baseline for the Simulation of Comparative Example A

Stage 30 consists of a gas stripper that contains 3 stages. The function of a stripper is described above.

The H₂ rich vapor stream from the stripper is cooled down to 38° C. in a vent cooler and the DPO/BP is condensed in the vent cooler.

The H₂ removal unit is integrated to a PT CSP plant.

A DPO/BP makeup stream of 10 lb/h (4.53592 kg/h) is considered to be introduced to the loop permanently.

The N₂ makeup stream is determined for each simulated case 1, 2 and 3. A H₂ content of 1 ppb in the makeup stream is assumed.

The consideration and the presence of other degradation products than H₂ are ignored. The simulation assumes any mass of H₂ that is formed from results in a deduction of the same mass of DPO/BP.

The stripper liquid inlet is selected to be at an altitude of 20 meters above the solar field and the hot header.

The ASPEN™ PLUS results from Example 2 were used to calculate the energy demands as follows:

Additional pump power of Comparative Example A=pump power of recovery return pump of Example A=Additional pump power of Example 2*mass flow of vapor stripper exit stream (c) of Example 2/mass flow to vent cooler stream (g)

Additional solar power from solar field for cooling of stripper outlet of Comparative Example A=vent cooler 47 power of Example 2*mass flow of vapor stripper exit stream (c) of Example 2/mass flow to vent cooler stream (g)−pump power of recovery return pump of Comparative Example A.

The required solar power from solar field for additional pumping=pump power of recovery return pump of Comparative Example A/0.7/0.37.

Portion of thermal consumption of unit from thermal power available from solar field=(The required solar power from solar field for additional pumping+the required solar power from solar field for cooling of stripper outlet)/270000 kW*100.

Portion of electrical power consumption of unit from total electrical power produced=(additional pump power of Comparative Example A+required solar power from solar field for additional pumping*0.37)/50000 kW*100.

### Three Simulation Conditions Used for Comparative Example A

The input values for three cases used in this Comparative Example A is described in Table VI.

Case 1 assumed new DPO/BP based HTF at 99.9% purity for which a H₂ generation rate of 0.66 g/hr in the solar field and 1.702 g/hr in the hot header is assumed.

Case 2 and 3 assume the same type of HTF, but so much aged that it contains 10% degradation products, for which a H₂ generation rate of 2.987 g/hr in the solar field and 7.701 g/hr in the hot header is assumed.

In case 1 and 2, the H₂ target concentration at the output of the solar field of 1 ppb which is as low as converted from the partial pressure specified by Schott referenced above. Case 3 simulates the H₂ target concentration at the output of the solar field to be at about 10 ppb.

### Results for Comparative Example A

The results of the simulation of this Comparative Example A are recorded in Tables VI and VII. Table VII is a summary of specific results.

Because of the DPO/BP recovery unit which condenses most of the DPO/BP from the stripper outlet, the DPO/BP makeup rate is the same as in Example 2.

The N₂ demand of Comparative Example A is 118 times higher than for Example 2. This is because no N₂ is recovered via H₂ separation in Comparative Example A. The cost of such high N₂ demands for a PT CSP plant would most likely also be high. Contrary to Example 2, 100% of the stream leaving stage 30 needs to be condensed in the cooler. Furthermore, there is more fresh N₂ in Comparative Example A compared to Example 2 that needs to be brought up to 293° C. operating temperature. The N₂ stream at 20° C. is heated by the contact of DPO/BP in the stripper. This heat up energy comes from the solar field via the feed stream to the stripper.

Consequently, the portion of thermal consumption of the unit from thermal power available from solar field of Comparative Example A is about 16 times bigger than in Example 2. The portion of electrical power consumption of the process from total electrical power produced is even 25 times bigger for Comparative Example A than Example 2.

TABLE VI
Input/Output Values of the Simulation of Comparative Example A

| | | | Case 1 | Case 2 | Case 3 |
|---|---|---|---|---|---|
| | Property | Unit | Values | Values | Values |
| Output | DPO/BP makeup rate during operation | kg/hr | 4.5 | 4.5 | 4.5 |
| | N₂ makeup rate during operation | kg/hr | 1513 | 5887 | 751 |
| | Additional pump power | kW | 0.17 | 0.63 | 0.08 |
| | Required solar power from solar field for | kW | 298 | 1159 | 148 |
| | additional pump | | | | |
| | Required solar power from solar field for | kW | 0.67 | 2.45 | 0.31 |
| | cooling of stripper outlet | | | | |
| | Portion of thermal consumption of unit from | % | 0.11 | 0.43 | 0.05 |
| | thermal power available from solar field | | | | |
| | Portion of electrical power consumption of | % | 0.22 | 0.86 | 0.11 |
| | unit from total electrical power produced | | | | |

TABLE VII
Summary of Most Relevant Output
Values of Comparative Example A

| Property | Unit | Case 1 | Case 2 | Case 3 |
|---|---|---|---|---|
| H₂ concentration at the exit of solar | ppb | 0.93 | 1.04 | 9.90 |
| field | | | | |
| Operation temperature of stage 30 | ° C. | 293 | 293 | 293 |
| outlet | | | | |
| Operating pressure of stage 30 outlet | bara | 10.40 | 10.40 | 10.40 |
| Portion of thermal consumption of | % | 0.11 | 0.43 | 0.05 |
| unit from thermal power available | | | | |
| from solar field | | | | |
| N₂ makeup rate during operation | kg/hr | 0.82 | 3.20 | 0.41 |
| per MT circulated DPO/BP | | | | |

The H₂ concentration could be reduced below 15 ppb with the processes described in all three examples (Examples 1 and 2 and Comparative Example A). In addition, Example 2 and Comparative Example A meets a H₂ concentration of 1 ppb which is received if the partial pressure specified by Schott referenced above is converted via equations (1) and (3).

The makeup rate of DPO/BP in Example 2 and Comparative Example A is set to 4.5 kg/hr during operation and the makeup rate of DPO/BP in Example 1 is set to 15.0 kg/hr. These makeup rate values are comparable to current makeup rates used in CSP plants for losses encountered in CSP plants.

Further optimization of N₂ makeup may be possible in any of the Examples. For instance, the change to a catalytic oxidation unit as H₂ vapor separation 49 method could be implemented in Example 1, similarly as it is done in Example 2. However N₂ makeup will also depend on system losses and what is necessary to purge impurities and degradation products from the N₂ recycle loop.

Comparative Example A requires 118 times more N₂ than Example 2. This is because no N₂ is recovered in Comparative Example A. All N₂ that leaves stage 30 in Comparative Example A is separated and exits the system. In the present invention, on the other hand, there is less N₂ consumption than Comparative Example A which is an advantage over the process of Comparative Example A.

Example 2 has the lowest energy demand. Less than 0.03% by weight of the thermal energy that is available from the solar field is required in Example 2. The electrical and thermal energy demand of Example 1 is with 1.51% even more than 50 times higher than in example 2. This is because the pressure of the total DPO/BP stream (a) is reduced in Example 1. The

re-pressurizing of the liquid outlet from stage 30 via pump 34 contributes the most to the higher energy demand of Example 1 versus Example 2.

Comparative Example A also consumes 25 times more power than Example 2. This is because of the required heat to bring the N₂ makeup flow to the operating temperature, which is much higher in Comparative Example A compared to Example 2 due to the higher N₂ makeup rate in Comparative Example A.

Overall, the process design of Example 2 is a preferred embodiment because the process of Example 2 can reduce the H₂ concentration to as low as 1 ppb and the design of Example 2 consumes the least amount of energy and N₂.

In summary, the present invention is directed to a new two stage process to reduce the concentration of dissolved H₂ in a HACL below 1.5 ppb. The process is able to operate at over 7.5 bara pressure and 270° C. which include the operating conditions of the heat transfer fluid useful in a concentrated solar power (CSP) plant. The energy demand for the process in a parabolic trough (PT) CSP plant is below 0.03% of thermal energy available from a solar field.

1. A process for increasing the service life of a solar receiver comprising
(a) contacting a hydrogen atom containing liquid stream with an inert gas stream in a stripping process that includes a stripper for a time sufficient to transfer at least a portion of the concentration of dissolved hydrogen present in the hydrogen atom containing liquid stream to the inert gas stream, wherein the hydrogen atom containing liquid stream is a heat transfer fluid charged through the stripper that operates above about 270° C. and above about 7.5 bar absolute; wherein the hydrogen atom containing liquid stream contains a first initial elevated concentration of dissolved hydrogen, before the hydrogen atom containing liquid stream is contacted with the inert gas stream; and wherein the contacting is performed under predetermined process conditions such that: (i) at least a portion of the first initial elevated concentration of dissolved hydrogen in the hydrogen atom containing liquid stream is transferred from the hydrogen atom containing liquid to the inert gas stream during the time the hydrogen atom containing liquid stream contacts the inert gas stream, and (ii) a second reduced concentration of dissolved hydrogen remains in the hydrogen atom containing liquid stream after the hydrogen atom containing liquid stream contacts the inert gas stream; and
(b) passing the hydrogen atom containing liquid stream having the second reduced concentration of dissolved hydrogen through a solar receiver.

2. The process of claim 1, including the steps of (c) removing the hydrogen from the inert gas stream to form a hydrogen-free inert gas stream; and (d) recycling the hydrogen-free inert gas stream from step (c) to the contacting step (a) of claim 1 such that the hydrogen-free inert gas recycle stream contacts the hydrogen atom containing liquid.

3. The process of claim 1, wherein the first initial elevated concentration of dissolved hydrogen in the hydrogen atom containing liquid stream is greater than 0.1 ppb.

4. The process of claim 1, wherein the first initial elevated concentration of dissolved hydrogen is reduced to a second reduced hydrogen concentration of less than about 50 ppb.

5. (canceled)

6. The process of any of the preceding claims, wherein the contacting step (a) is performed by mixing the inert gas stream with the hydrogen atom containing liquid stream in a single stage stripper or a multiple stage stripper.

7. (canceled)

8. The process of claim 2, wherein the removing step (c) is carried out using (i) a membrane, (ii) a proton exchange membrane, (iii) a catalytic oxidation process, (iv) an absorption (chemisorption) material or (v) an adsorption material.

9. The process of claim 1, wherein the inert gas stream is nitrogen.

10. (canceled)

11. The process of claim 1, wherein the heat transfer fluid is a blend of diphenyl oxide and biphenyl.

12. The process of claim 1, wherein the heat transfer fluid is a polysiloxane.

13. The process of claim 1, wherein the passing step (b) is carried out by passing the hydrogen atom containing liquid stream having the second reduced concentration of dissolved hydrogen through the internal space of a steel tube of the solar receiver.

14. The process of claim 1, wherein the concentration of hydrogen in the hydrogen atom containing liquid is reduced to a concentration of lower than about 15 ppb.

15. The process of claim 1, wherein the concentration of hydrogen in the hydrogen atom containing liquid is reduced to a concentration of lower than about 10 ppb.

16. The process of claim 1, wherein the concentration of hydrogen in the hydrogen atom containing liquid is reduced to a concentration of lower than about 1.5 ppb.

17. The process of claim 1, wherein the process is used in a concentrated solar power plant with vacuum insulated receivers.

18. The process of claim 1, wherein the energy demand for the process is less than about 0.035 percent of the maximum energy provided by the solar field.

19. (canceled)

20. The process of claim 1, wherein the inert gas stream used in contacting the hydrogen atom containing liquid stream further includes 0 wt. % to 99.99 wt. % of vaporized HACL.
